(19) United States
(12) Patent Application Publication
(10) Pub. No.: US 2023/0224451 A1
(43) Pub. Date: Jul. 13, 2023

(54) INFORMATION PROCESSING APPARATUS, INFORMATION PROCESSING METHOD, AND PROGRAM

(71) Applicant: FUJIFILM Corporation, Tokyo (JP)

(72) Inventors: Fuminori IRIE, Saitama-shi (JP); Takashi Aoki, Saitama-shi (JP); Kazunori Tamura, Saitama-shi (JP); Masahiko Miyata, Saitama-shi (JP); Yasunori Murakami, Saitama-shi (JP)

(73) Assignee: FUJIFILM Corporation, Tokyo (JP)

(21) Appl. No.: 18/184,667

(22) Filed: Mar. 16, 2023

Related U.S. Application Data
(63) Continuation of application No. PCT/JP2021/028992, filed on Aug. 4, 2021.

(30) Foreign Application Priority Data
Sep. 30, 2020 (JP) 2020-166413

(51) Int. Cl. H04N 13/349; H04N 13/383; H04N 13/117

(52) U.S. Cl. CPC H04N 13/349; H04N 13/117; H04N 13/383

(57) ABSTRACT

An information processing apparatus includes a processor, and a memory built in or connected to the processor, in which the processor acquires a subject image showing a subject present inside a three-dimensional region, which is an observation target, in a case in which an inside of the three-dimensional region is observed from a viewpoint position determined based on coordinates inside the three-dimensional region corresponding to an indication position that is indicated inside the three-dimensional region or that is indicated inside a reference image showing a state of the inside of the three-dimensional region in a case in which the inside of the three-dimensional region is observed from a reference position.

### CROSS-REFERENCE TO RELATED APPLICATIONS

This application is a continuation application of International Application No. PCT/JP2021/028992, filed Aug. 4, 2021, the disclosure of which is incorporated herein by reference in its entirety. Further, this application claims priority under 35 USC 119 from Japanese Patent Application No. 2020-166413 filed Sep. 30, 2020, the disclosure of which is incorporated by reference herein.

### BACKGROUND

### 1. Technical Field

The technology of the present disclosure relates to an information processing apparatus, an information processing method, and a program.

### 2. Description of the Related Art

JP2019-133309A discloses a program causing a computer to execute a step of setting a virtual space for providing a virtual experience to a user, a step of setting a plurality of movement areas in the virtual space, a step of setting a virtual viewpoint in the virtual space, a step of indicating a predetermined movement area among the plurality of movement areas according to a part of movement of a body of the user, a step of moving the virtual viewpoint to the predetermined movement area in a case in which a distance between the virtual viewpoint and the predetermined movement area is equal to or less than a first threshold value, and a step of not moving the virtual viewpoint to the predetermined movement area in a case in which the distance between the virtual viewpoint and the predetermined movement area exceeds the first threshold value.

### SUMMARY

One embodiment according to the technology of the present disclosure provides an information processing apparatus, an information processing method, and a program which enable a user to observe a state inside a three-dimensional region from various positions.

A first aspect according to the technology of the present disclosure relates to an information processing apparatus comprising a processor, and a memory built in or connected to the processor, in which the processor acquires a subject image showing a subject present inside a three-dimensional region, which is an observation target, in a case in which an inside of the three-dimensional region is observed from a viewpoint position determined based on coordinates inside the three-dimensional region corresponding to an indication position that is indicated inside the three-dimensional region or that is indicated inside a reference image showing a state of the inside of the three-dimensional region in a case in which the inside of the three-dimensional region is observed from a reference position.

A second aspect according to the technology of the present disclosure relates to the information processing apparatus according to the first aspect, in which the processor derives the coordinates based on an observation state in which the inside of the three-dimensional region is observed, and the indication position.

A third aspect according to the technology of the present disclosure relates to the information processing apparatus according to the second aspect, in which the observation state is determined according to an observation position at which the inside of the three-dimensional region is observed.

A fourth aspect according to the technology of the present disclosure relates to the information processing apparatus according to the third aspect, in which the processor decides an observation position indication range in which the observation position is able to be indicated, according to an attribute of an indication source.

A fifth aspect according to the technology of the present disclosure relates to the information processing apparatus according to the fourth aspect, in which the processor acquires a three-dimensional region inside-state image showing a state of the inside of the three-dimensional region in a case in which the three-dimensional region is observed in the observation state, and the three-dimensional region inside-state image is an image in which the observation position indication range inside the three-dimensional region and a range other than the observation position indication range are shown in a state of being distinguishable from each other.

A sixth aspect according to the technology of the present disclosure relates to the information processing apparatus according to the fifth aspect, in which the reference image is an image based on the three-dimensional region inside-state image.

A seventh aspect according to the technology of the present disclosure relates to the information processing apparatus according to any one of the second to sixth aspects, in which the processor derives the coordinates based on a correspondence relationship between an image showing a state of the inside of the three-dimensional region in a case in which the inside of the three-dimensional region is observed in the observation state and a three-dimensional region image in which the three-dimensional region is shown and a position is able to be specified by the coordinates.

An eighth aspect according to the technology of the present disclosure relates to the information processing apparatus according to any one of the first to seventh aspects, in which the reference image is a virtual viewpoint image generated based on a plurality of images obtained by imaging the inside of the three-dimensional region with a plurality of imaging apparatuses or an image based on a captured image obtained by imaging the inside of the three-dimensional region.

A ninth aspect according to the technology of the present disclosure relates to the information processing apparatus according to the eighth aspect, in which the indication position indicated inside the reference image is a specific position inside the virtual viewpoint image or inside the captured image.

A tenth aspect according to the technology of the present disclosure relates to the information processing apparatus according to any one of the first to ninth aspects, in which the reference image is an image including a first mark at which the indication position inside the reference image is able to be specified.

An eleventh aspect according to the technology of the present disclosure relates to the information processing apparatus according to any one of the first to tenth aspects, in which the subject image includes a second mark at which the indication position indicated inside the reference image is able to be specified.

A twelfth aspect according to the technology of the present disclosure relates to the information processing apparatus according to any one of the first to eleventh aspects, in which, in a case in which an object image showing an object present inside the three-dimensional region in a case in which the inside of the three-dimensional region is observed from a position within a range in which a distance from the indication position is equal to or less than a threshold value is stored in a storage region, the processor acquires the object image instead of the subject image.

A thirteenth aspect according to the technology of the present disclosure relates to the information processing apparatus according to any one of the first to twelfth aspects, in which the coordinates related to a specific region inside the three-dimensional region are coordinates indicating a position higher than an actual position of the specific region inside the three-dimensional region.

A fourteenth aspect according to the technology of the present disclosure relates to the information processing apparatus according to any one of the first to thirteenth aspects, in which the indication position indicated inside the three-dimensional region is a position indicated on a first line from a viewpoint at which the inside of the three-dimensional region is observed toward a gaze point, and the indication position indicated inside the reference image is a position indicated on a second line from the reference position toward a point designated inside the reference image.

A fifteenth aspect according to the technology of the present disclosure relates to the information processing apparatus according to any one of the first to fourteenth aspects, in which the indication position indicated inside the three-dimensional region is a position selected from at least one first candidate position, the indication position indicated inside the reference image is a position selected from at least one second candidate position, and the processor associates a first reduction image obtained by reducing the subject image in a case in which the inside of the three-dimensional region is observed from the first candidate position, with the at least one first candidate position, and associates a second reduction image obtained by reducing the subject image in a case in which the inside of the three-dimensional region is observed from the second candidate position, with the at least one second candidate position.

A sixteenth aspect according to the technology of the present disclosure relates to the information processing apparatus according to any one of the first to fifteenth aspects, in which the processor detects the indication position based on a designated region image showing a region designated inside the three-dimensional region.

A seventeenth aspect according to the technology of the present disclosure relates to the information processing apparatus according to any one of the first to sixteenth aspects, in which the subject image is a virtual viewpoint image generated based on a plurality of images obtained by imaging the inside of the three-dimensional region with a plurality of imaging apparatuses.

An eighteenth aspect according to the technology of the present disclosure relates to an information processing method comprising acquiring a subject image showing a subject present inside a three-dimensional region, which is an observation target, in a case in which an inside of the three-dimensional region is observed from a viewpoint position determined based on coordinates inside the three-dimensional region corresponding to an indication position that is indicated inside the three-dimensional region or that is indicated inside a reference image showing a state of the inside of the three-dimensional region in a case in which the inside of the three-dimensional region is observed from a reference position.

A nineteenth aspect according to the technology of the present disclosure relates to a program causing a computer to execute a process comprising acquiring a subject image showing a subject present inside a three-dimensional region, which is an observation target, in a case in which an inside of the three-dimensional region is observed from a viewpoint position determined based on coordinates inside the three-dimensional region corresponding to an indication position that is indicated inside the three-dimensional region or that is indicated inside a reference image showing a state of the inside of the three-dimensional region in a case in which the inside of the three-dimensional region is observed from a reference position.

### BRIEF DESCRIPTION OF THE DRAWINGS

Exemplary embodiments of the technology of the disclosure will be described in detail based on the following figures, wherein:

FIG. 1 is a conceptual diagram showing an example of a configuration of an information processing system according to a first embodiment;

FIG. 2 is a conceptual diagram showing an example of a configuration of a three-dimensional region image;

FIG. 3 is a block diagram showing an example of a hardware configuration of an electric system of a user device;

FIG. 4 is a schematic perspective view showing an example of a state in which an inside of a soccer stadium is imaged by an imaging apparatus of a smart device;

FIG. 5 is a conceptual diagram showing an example of contents of user device side processing according to the first embodiment;

FIG. 6 is a conceptual diagram showing an example of the contents of the user device side processing according to the first embodiment;

FIG. 7 is a conceptual diagram showing an example of the contents of the user device side processing according to the first embodiment;

FIG. 8 is a conceptual diagram showing an example of the contents of the user device side processing according to the first embodiment;

FIG. 9 is a conceptual diagram showing an example of contents of image generation processing according to the first embodiment;

FIG. 10 is a conceptual diagram showing an example of the contents of the image generation processing according to the first embodiment;

FIG. 11 is a flowchart showing an example of a flow of the user device side processing according to the first embodiment;

FIG. 12 is a flowchart showing an example of a flow of the image generation processing according to the first embodiment;

FIG. 13 is a conceptual diagram showing a modification example of the contents of the image generation processing according to the first embodiment;

FIG. 14 is a conceptual diagram showing a modification example of the contents of the image generation processing according to the first embodiment;

FIG. 15 is a conceptual diagram showing an example of a configuration of an HMD;

FIG. 16 is a conceptual diagram showing an example of contents of HMD side processing according to a second embodiment;

FIG. 17 is a conceptual diagram showing an example of a display aspect of a display of the HMD;

FIG. 18 is a conceptual diagram used for describing a method of setting a provisional indication position;

FIG. 19 is a conceptual diagram showing an example of the contents of the HMD side processing according to the second embodiment;

FIG. 20 is a conceptual diagram showing an example of a configuration of a provisional indication position inclusion HMD image;

FIG. 21 is a conceptual diagram showing an example of contents of image generation processing according to the second embodiment;

FIG. 22 is a conceptual diagram showing an example of a configuration of an indication position candidate inclusion different-viewpoint position image;

FIG. 23 is a conceptual diagram showing an example of the contents of the HMD side processing according to the second embodiment;

FIG. 24 is a conceptual diagram showing an example of display contents of the display of the HMD;

FIG. 25 is a conceptual diagram showing an example of the contents of the HMD side processing according to the second embodiment;

FIG. 26 is a conceptual diagram showing an example of the contents of the image generation processing according to the second embodiment;

FIG. 27 is a flowchart showing an example of a flow of user device side processing according to the second embodiment;

FIG. 28 is a flowchart showing an example of a flow of the HMD side processing according to the second embodiment;

FIG. 29 is a continuation of the flowchart shown in FIG. 28;

FIG. 30 is a flowchart showing an example of a flow of image generation processing according to the second embodiment;

FIG. 31 is a conceptual diagram showing a modification example of the contents of the image generation processing according to the second embodiment;

FIG. 32 is a schematic perspective view showing an example of a state in which a finger of a user is imaged by a plurality of imaging apparatuses;

FIG. 33 is a conceptual diagram showing an example of a state in which the indication position candidate inclusion different-viewpoint position image is displayed on the display of the user device;

FIG. 34 is a conceptual diagram showing a modification example of the contents of the image generation processing according to the second embodiment;

FIG. 35 is a conceptual diagram showing a modification example of the contents of the image generation processing according to the second embodiment;

FIG. 36 is a conceptual diagram showing an example of a configuration of the indication position candidate inclusion different-viewpoint position image;

FIG. 37 is a conceptual diagram showing a modification example of the contents of the HMD side processing according to the second embodiment;

FIG. 38 is a conceptual diagram showing a modification example of the contents of the image generation processing according to the second embodiment;

FIG. 39 is a conceptual diagram showing an example of a state in which the indication position candidate inclusion different-viewpoint position image is displayed on the display of the user device;

FIG. 40 is a conceptual diagram showing an example of a configuration of an information processing system according to a third embodiment;

FIG. 41 is a conceptual diagram showing an example of a configuration of a spectator seat information inclusion three-dimensional region image;

FIG. 42 is a conceptual diagram showing an example of contents of user device side processing according to the third embodiment;

FIG. 43 is a conceptual diagram showing an example of contents of image generation processing according to the third embodiment;

FIG. 44 is a conceptual diagram showing an example of the contents of the user device side processing according to the third embodiment;

FIG. 45 is a conceptual diagram showing an example of a state in which a reference image is displayed on the display of the user device;

FIG. 46 is a flowchart showing an example of a flow of the user device side processing according to the third embodiment;

FIG. 47 is a flowchart showing an example of a flow of observation range limitation processing according to the third embodiment; and

FIG. 48 is a conceptual diagram showing an example of a state in which a program stored in a storage medium is installed in a computer of an information processing apparatus.

### DETAILED DESCRIPTION

An example of embodiments of an information processing apparatus, an information processing method, and a program according to the technology of the present disclosure will be described with reference to the accompanying drawings.

First, the terms used in the description below will be described.

CPU refers to an abbreviation of “central processing unit”. NVM refers to an abbreviation of “non-volatile memory”. RAM refers to an abbreviation of “random access memory”. SSD refers to an abbreviation of “solid state drive”. HDD refers to an abbreviation of “hard disk drive”. EEPROM refers to an abbreviation of “electrically erasable and programmable read only memory”. I/F refers to an abbreviation of “interface”. ASIC refers to an abbreviation of “application specific integrated circuit”. PLD refers to an abbreviation of “programmable logic device”. FPGA refers to an abbreviation of “field-programmable gate array”. SoC refers to an abbreviation of “system-on-a-chip”. CMOS refers to an abbreviation of “complementary metal oxide semiconductor”. CCD refers to an abbreviation of “charge coupled device”. EL refers to an abbreviation of “electro-luminescence”. GPU refers to an abbreviation of “graphics processing unit”. LAN refers to an abbreviation of “local area network”. 3D refers to an abbreviation of “3 dimensions”. USB refers to an abbreviation of “universal serial bus”. “HMD” refers to an abbreviation of “head mounted display”. LTE refers to an abbreviation of “long term evolution”. 5G refers to an abbreviation of “5th generation (wireless technology for digital cellular networks)”. TDM refers to an abbreviation of “time-division multiplexing”. HMD refers to an abbreviation of “head mounted display”. Hereinafter, for convenience of description, a CPU is described as an example of a “processor” according to the technology of the present disclosure, but a “processor” according to the technology of the present disclosure may be a combination of a plurality of processing apparatuses, such as a CPU and a GPU. In a case in which the combination of the CPU and the GPU is applied as an example of a “processor” according to the technology of the present disclosure, the GPU is operated under the control of the CPU and is responsible for executing image processing.

In the description below, “match” refers to the match in the sense of including an error generally allowed in the technical field to which the technology of the present disclosure belongs, that is the error to the extent that it does not contradict the purpose of the technology of the present disclosure, in addition to the exact match.

### First Embodiment

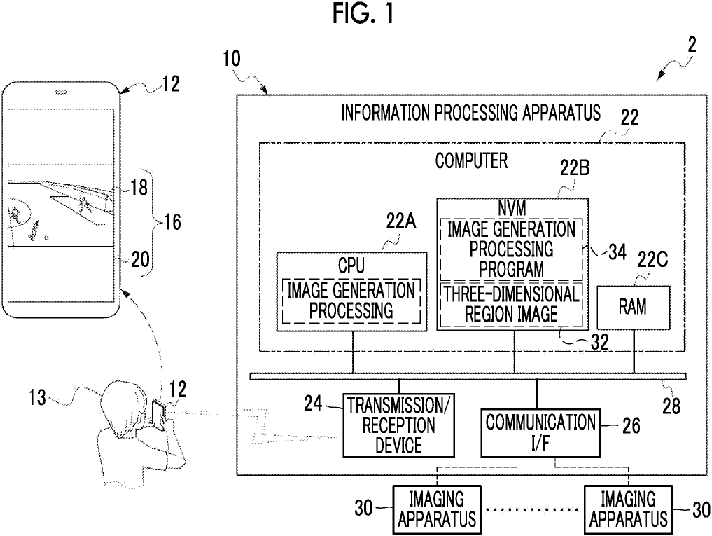

As shown in FIG. 1 as an example, an information processing system 2 comprises an information processing apparatus 10 and a user device 12.

It should be noted that, in the first embodiment, a server is applied as an example of the information processing apparatus 10. It should be noted that this is merely an example, and a personal computer may be applied, a plurality of personal computers may be applied, a plurality of servers may be applied, or a device in which the personal computer and the server are combined may be applied.

Moreover, in the first embodiment, a smartphone is applied as an example of the user device 12. It should be noted that the smartphone is merely an example, and, for example, a personal computer may be applied, or a portable multifunctional terminal, such as a tablet terminal or an HMD, may be applied.

In addition, in the first embodiment, the information processing apparatus 10 and the user device 12 are connected in a communicable manner via, for example, a base station (not shown). The communication standards used in the base station include a wireless communication standard including a 5G standard, an LTE standard, and the like, a wireless communication standard including a WiFi (802.11) standard and/or a Bluetooth (registered trademark) standard, and a wired communication standard including a TDM standard and/or an Ethernet (registered trademark) standard.

The information processing apparatus 10 acquires an image, and transmits the acquired image to the user device 12. Here, the image refers to, for example, a captured image obtained by imaging and an image generated based on the captured image. An example of the image generated based on the captured image is a virtual viewpoint image.

The user device 12 is used by a user 13. The user device 12 comprises a touch panel display 16. The touch panel display 16 is realized by a display 18 and a touch panel 20. Examples of the display 18 include an EL display (for example, an organic EL display or an inorganic EL display). It should be noted that the display is not limited to the EL display, and another type of display, such as a liquid crystal display, may be applied.

The touch panel display 16 is formed by superimposing the touch panel 20 on a display region of the display 18 or by forming an in-cell type in which a touch panel function is built in the display 18. It should be noted that the in-cell type is merely an example, and an out-cell type or an on-cell type may be applied.

The user device 12 executes processing (for example, user device side processing described below) in response to an instruction received from the user by the touch panel 20 or the like. For example, the user device 12 exchanges various types of information with the information processing apparatus 10 in response to the instruction received from the user by the touch panel 20 or the like.

The user device 12 receives the image transmitted from the information processing apparatus 10 to display the received image on the display 18. The user 13 watches the image displayed on the display 18.

The information processing apparatus 10 comprises a computer 22, a transmission/reception device 24, a communication I/F 26, and a bus 28. The computer 22 comprises a CPU 22A, an NVM 22B, and a RAM 22C, and the CPU 22A, the NVM 22B, and the RAM 22C are connected to each other via the bus 28. In the example shown in FIG. 1, one bus is shown as the bus 28 for convenience of illustration, but a plurality of buses may be used. In addition, the bus 28 may include a serial bus or a parallel bus configured by a data bus, an address bus, a control bus, and the like.

The CPU 22A is an example of a “processor” according to the technology of the present disclosure. The CPU 22A controls the entire information processing apparatus 10. Various parameters and various programs are stored in the NVM 22B. Examples of the NVM 22B include an EEPROM, an SSD, and/or an HDD. The RAM 22C is an example of a “memory” according to the technology of the present disclosure. Various types of information are transitorily stored in the RAM 22C. The RAM 22C is used as a work memory by the CPU 22A.

The transmission/reception device 24 is connected to the bus 28. The transmission/reception device 24 is a device including a communication processor (not shown), an antenna, and the like, and transmits and receives various types of information to and from the user device 12 via the base station (not shown) under the control of the CPU 22A. That is, the CPU 22A exchanges various types of information with the user device 12 via the transmission/reception device 24.

The communication I/F 26 is realized by a device including an FPGA, for example. The communication I/F 26 is connected to a plurality of imaging apparatuses 30 via a LAN cable (not shown). The imaging apparatus 30 is an imaging device including a CMOS image sensor, and has an optical zoom function and/or a digital zoom function. It should be noted that, instead of the CMOS image sensor, another type of image sensor, such as a CCD image sensor, may be adopted.

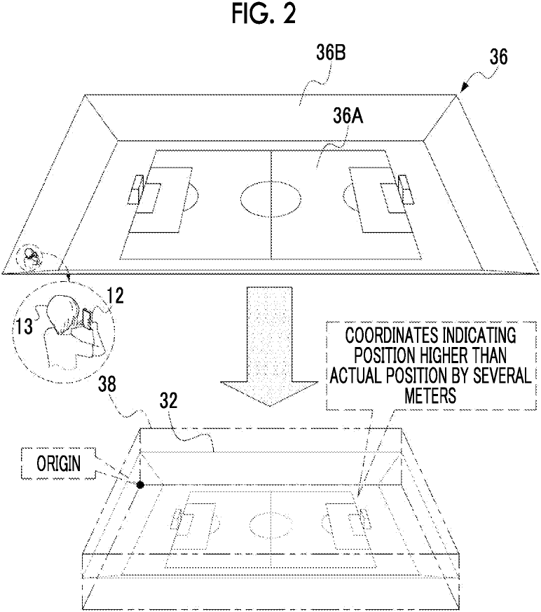

The plurality of imaging apparatuses 30 are installed in a soccer stadium 36 (see FIG. 2) and image a subject inside the soccer stadium 36. The captured image obtained by imaging the subject with the imaging apparatus 30 is used, for example, for generating the virtual viewpoint image. Therefore, the plurality of imaging apparatuses 30 is installed at different locations inside the soccer stadium 36 (see FIG. 2), respectively, that is, at locations at which a plurality of captured images capable of generating the virtual viewpoint images can be obtained.

The communication I/F 26 is connected to the bus 28, and controls the exchange of various types of information between the CPU 22A and the plurality of imaging apparatuses 30. For example, the communication I/F 26 controls the plurality of imaging apparatuses 30 in response to a request from the CPU 22A. The communication I/F 26 outputs the captured image (hereinafter, also simply referred to as a “captured image”) obtained by the imaging with each of the plurality of imaging apparatuses 30 to the CPU 22A. It should be noted that, here, although the communication I/F 26 is described as a wired communication I/F, a wireless communication I/F, such as a high-speed wireless LAN, may be applied.

The NVM 22B stores a three-dimensional region image 32 and an image generation processing program 34. The details will be described below, but the three-dimensional region image 32 is a three-dimensional image showing a state of the three-dimensional region, and coordinates at which a position inside the three-dimensional region can be specified are given to the three-dimensional region image 32.

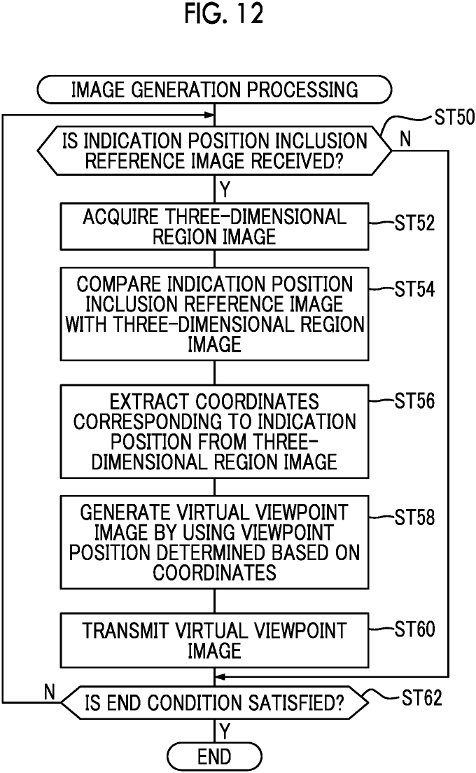

The image generation processing program 34 is an example of a “program” according to the technology of the present disclosure. The CPU 22A performs image generation processing (see FIG. 12) by reading out the image generation processing program 34 from the NVM 22B and executing the image generation processing program 34 on the RAM 22C.

As shown in FIG. 2 as an example, the three-dimensional region image 32 is a three-dimensional image showing the soccer stadium 36. The soccer stadium 36 is an example of a “three-dimensional region” according to the technology of the present disclosure. The soccer stadium 36 is a three-dimensional region including a soccer field 36A and a spectator seat 36B constructed to surround the soccer field 36A, and is an observation target of the user 13. In the example shown in FIG. 2, a state is shown in which an observer, that is, the user 13 observes the inside of the soccer stadium 36 from the spectator seat 36B.

The coordinates at which the position inside the soccer stadium 36 can be specified are given to the three-dimensional region image 32. Here, as an example of the coordinates at which the position inside the soccer stadium 36 can be specified, three-dimensional coordinates at which a position inside a rectangular body 38 with one apex of the rectangular body 38 that surrounds the soccer stadium 36 as an origin can be specified are applied.

Coordinates related to a position of the soccer field 36A indicated by the three-dimensional region image 32 are coordinates indicating a position higher than an actual position of the soccer field 36A. Here, the coordinates related to the position of the soccer field 36A refer to coordinates given to the position of the soccer field 36A among the coordinates given to the three-dimensional region image 32. In addition, here, the coordinates indicating the position higher than the actual position are coordinates indicating the position higher than the actual position by a distance corresponding to an average height of a general adult, for example. It should be noted that the soccer field 36A is an example of a “specific region” according to the technology of the present disclosure.

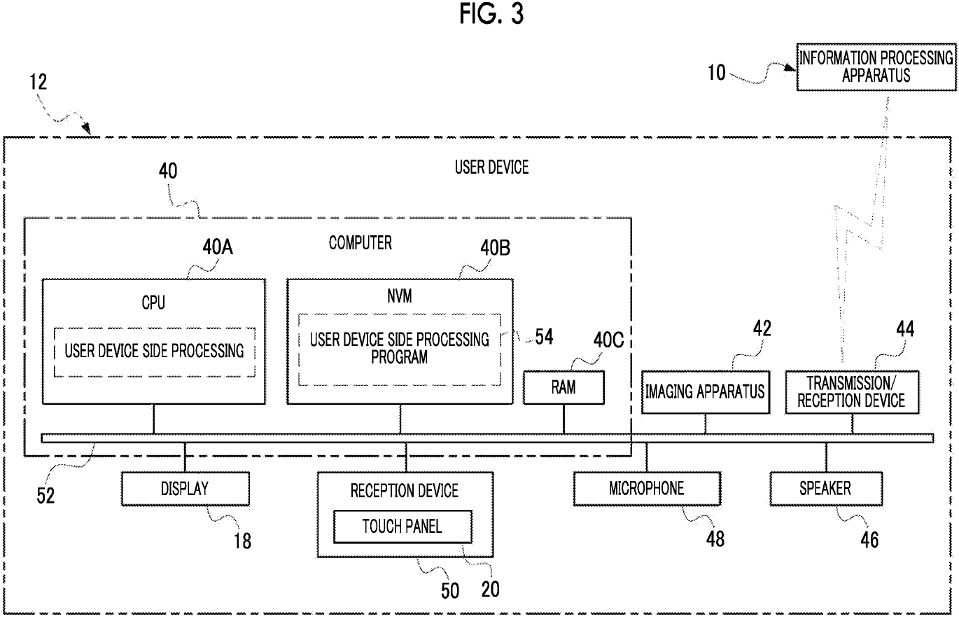

As shown in FIG. 3 as an example, the user device 12 comprises the display 18, a computer 40, an imaging apparatus 42, a transmission/reception device 44, a speaker 46, a microphone 48, a reception device 50, and a bus 52.

The computer 40 comprises a CPU 40A, an NVM 40B, and a RAM 40C, and the CPU 40A, the NVM 40B, and the RAM 40C are connected to each other via the bus 52. In the example shown in FIG. 3, one bus is shown as the bus 52 for convenience of illustration, but a plurality of buses may be used. In addition, the bus 52 may include a serial bus or a parallel bus configured by a data bus, an address bus, a control bus, and the like.

The CPU 40A controls the entire user device 12. Various parameters and various programs are stored in the NVM 40B. Examples of the NVM 40B include an EEPROM. Various types of information are transitorily stored in the RAM 40C. The RAM 40C is used as a work memory by the CPU 40A.

The imaging apparatus 42 is an imaging device including a CMOS image sensor, and has an optical zoom function and/or a digital zoom function. It should be noted that, instead of the CMOS image sensor, another type of image sensor, such as a CCD image sensor, may be adopted. The imaging apparatus 42 is connected to the bus 52, and the CPU 40A controls the imaging apparatus 42. The captured image obtained by the imaging with the imaging apparatus 42 is acquired by the CPU 40A via the bus 52.

The transmission/reception device 44 is connected to the bus 52. The transmission/reception device 44 is a device including a communication processor (not shown), an antenna, and the like, and transmits and receives various types of information to and from the information processing apparatus 10 via the base station (not shown) under the control of the CPU 40A. That is, the CPU 40A exchanges various types of information with the information processing apparatus 10 via the transmission/reception device 44.

The speaker 46 converts an electric signal into the sound. The speaker 46 is connected to the bus 52. The speaker 46 receives the electric signal output from the CPU 40A via the bus 52, converts the received electric signal into the sound, and outputs the sound obtained by the conversion from the electric signal to the outside of the user device 12.

The microphone 48 converts the collected sound into the electric signal. The microphone 48 is connected to the bus 52. The CPU 40A acquires the electric signal obtained by the conversion from the sound collected by the microphone 48 via the bus 52.

The reception device 50 receives an instruction from the user 13 or the like. Examples of the reception device 50 include the touch panel 20 and a hard key (not shown). The reception device 50 is connected to the bus 52, and an instruction received by the reception device 50 is acquired by the CPU 40A.

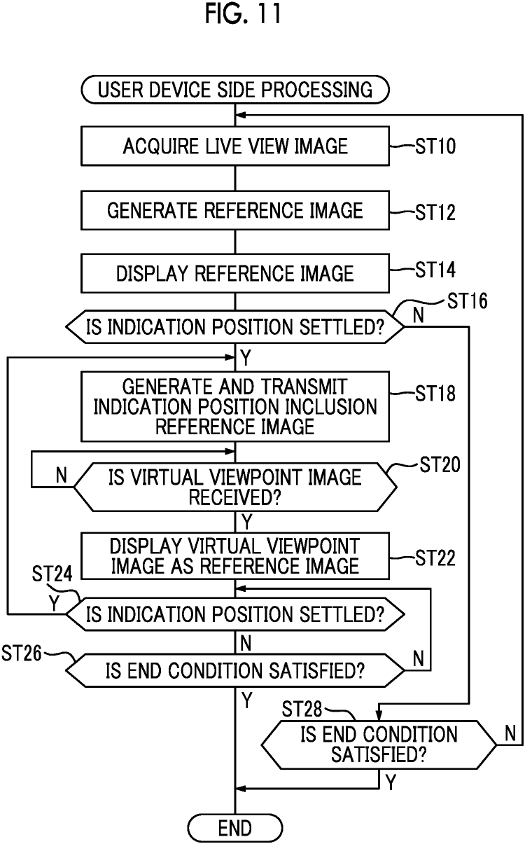

The NVM 40B stores a user device side processing program 54. The CPU 40A performs user device side processing (see FIG. 11) by reading out the user device side processing program 54 from the NVM 40B and executing the user device side processing program 54 on the RAM 40C.

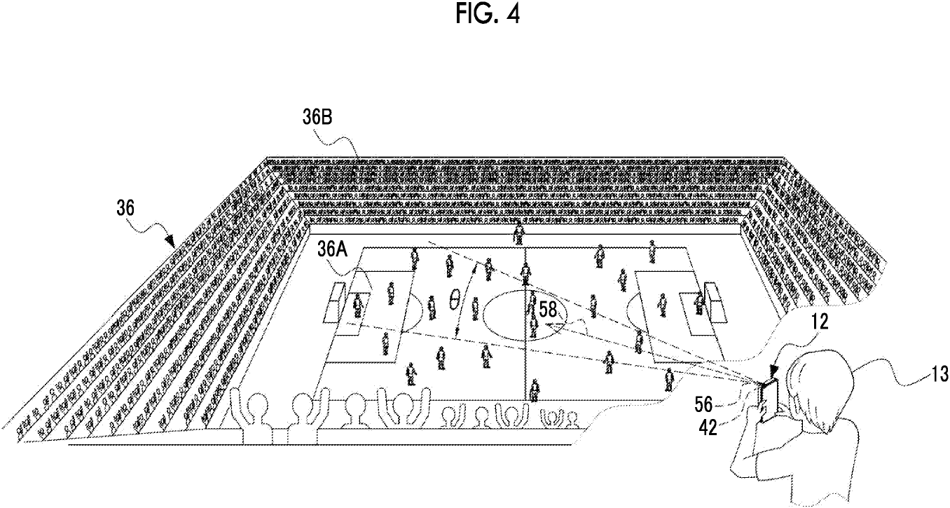

As shown in FIG. 4 as an example, an observation state in which the user 13 observes the inside of the soccer stadium 36 (hereinafter, also simply referred to as an “observation state”) is determined by a viewpoint position 56, a visual line direction 58, and an angle of view θ of the user 13. The viewpoint position 56 corresponds to a position at which the user 13 observes the inside of the soccer stadium 36 in a reality space, and is an example of a “reference position” and an “observation position” according to the technology of the present disclosure.

The viewpoint position 56 is a position corresponding to a position of the imaging apparatus 42 mounted on the user device 12, the visual line direction 58 is a direction corresponding to an optical axis direction of an imaging optical system (not shown) provided in the imaging apparatus 42, and the angle of view θ is an angle corresponding to an angle of view of the imaging apparatus 42. In the information processing system 2, a region observed by the user 13 in the reality space (real space) is specified from the captured image obtained by imaging the inside of the soccer stadium 36 with the imaging apparatus 42. Then, in the information processing system 2, a viewpoint position different from the viewpoint position 56 is set by using the captured image, and a subject image showing the subject present inside the soccer stadium 36 in a case in which the inside of the soccer stadium 36 is observed from the set viewpoint position is watched by the user 13. In order to realize such watching, the information processing system according to the first embodiment performs the following user device side processing and image generation processing.

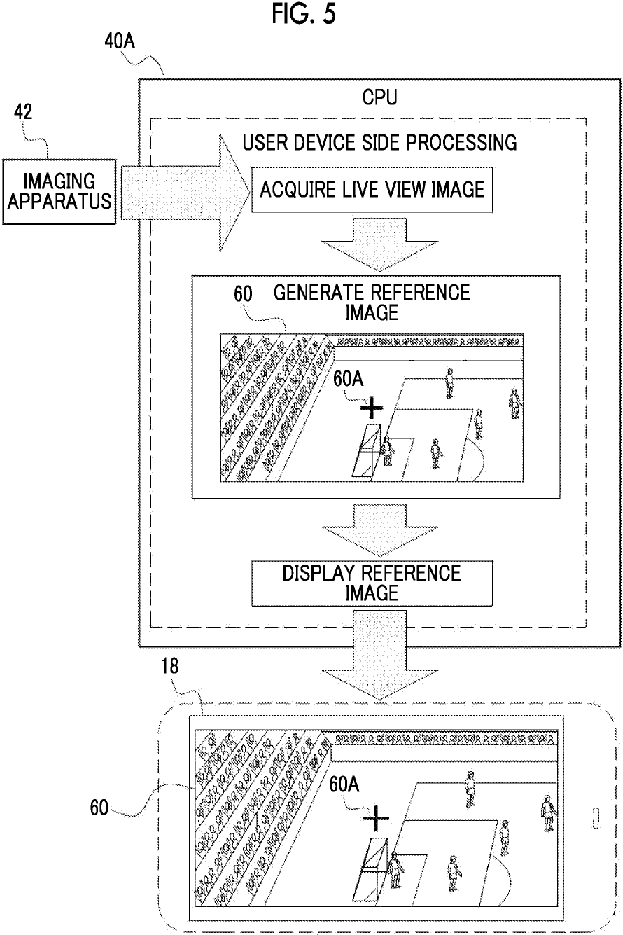

As shown in FIG. 5 as an example, in the user device side processing, the CPU 40A acquires a live view image obtained by the imaging with the imaging apparatus 42. The live view image is an image showing a designated region inside the soccer stadium 36. Here, the region designated inside the soccer stadium 36 refers to, for example, a region determined by the viewpoint position 56, the visual line direction 58, and the angle of view θ. The live view image is an example of an “image showing a state of the inside of the three-dimensional region in a case in which the inside of the three-dimensional region is observed in the observation state” according to the technology of the present disclosure. The CPU 40A generates a reference image 60 by using the acquired live view image.

The reference image 60 is an example of a “designated region image” according to the technology of the present disclosure. The reference image 60 is an image showing the state of the inside of the soccer stadium 36 in a case in which the inside of the soccer stadium 36 is observed from the viewpoint position 56 (see FIG. 4). The reference image 60 is an image based on the live view image. In the example shown in FIG. 5, an image in which a target mark 60A having a cross shape is superimposed on the live view image is shown as an example of the reference image 60. The target mark 60A is a mark that is displaced inside the reference image 60 in response to the instruction given by the user 13, and indicates the position indicated by the user 13 as the viewpoint position for the user 13 to observe the inside of the soccer stadium 36. That is, the target mark 60A is a mark at which the position indicated by the user 13 inside the reference image 60 can be specified. It should be noted that the position of the target mark 60A inside the reference image 60, that is, the position of the target mark 60A superimposed on the live view image is an example of an “indication position”, a “specific position inside the captured image”, and a “first mark” according to the technology of the present disclosure.

A home position of the target mark 60A is the center of the reference image 60. In the example shown in FIG. 5, the center of the target mark 60A is positioned at the center of the reference image 60. The CPU 40A displays the reference image 60 on the display 18.

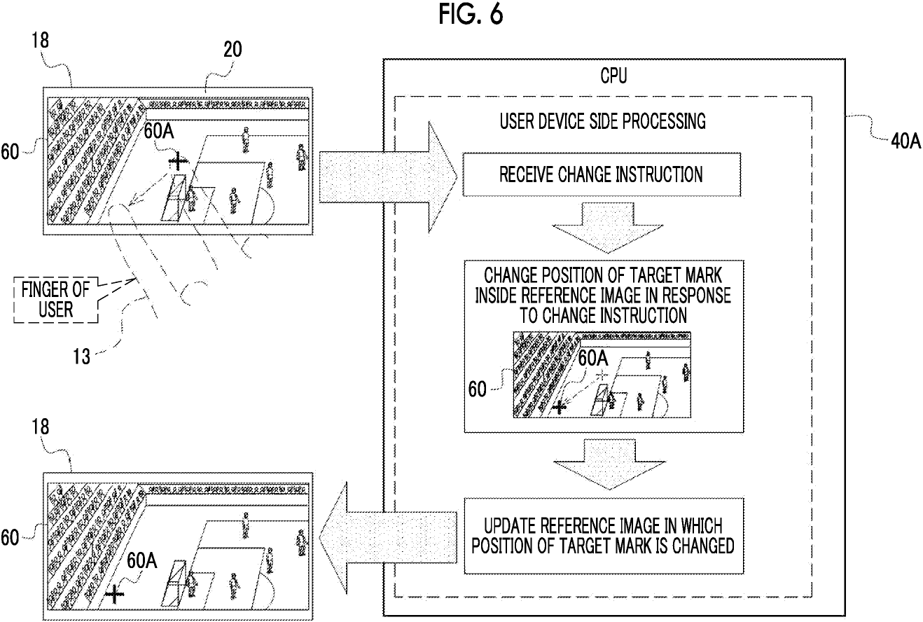

As shown in FIG. 6 as an example, in the user device side processing, in a case in which a change instruction, which is an instruction to change the position of the target mark 60A, is received by the touch panel 20 in a state in which the reference image 60 is displayed on the display 18, the CPU 40A changes the position of the target mark 60A inside the reference image 60 in response to the change instruction. The change instruction is a swipe performed with respect to the touch panel 20 on the target mark 60A displayed on the display 18. That is, the user 13 touches the target mark 60A via the touch panel 20 and slides the touched position on the touch panel 20 to indicate a change destination of the position of the target mark 60A. The CPU 40A updates the reference image 60 displayed on the display 18 with the reference image 60 in which the position of the target mark 60A is changed. It should be noted that, in a case in which the reference image 60 is the live view image, the position of the target mark 60A with respect to the reference image 60 may be moved by the user 13 moving the user device 12 instead of touching and changing the position of the target mark 60A on the display 18.

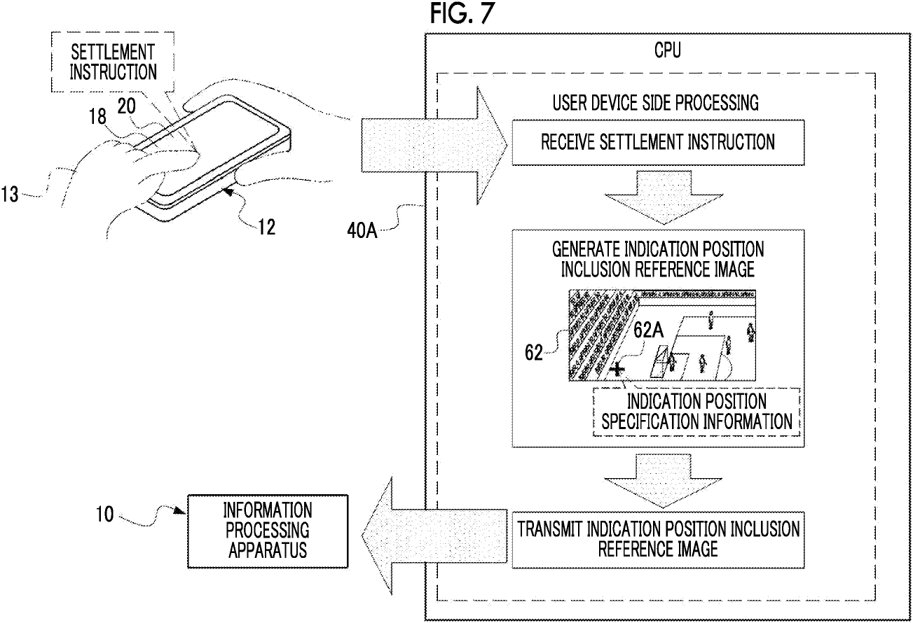

As shown in FIG. 7 as an example, in the user device side processing, in a case in which a settlement instruction, which is an instruction to settle the position of the target mark 60A inside the reference image 60, is received by the touch panel 20 in a state in which the reference image 60 is displayed on the display 18, the CPU 40A generates an indication position inclusion reference image 62. The indication position inclusion reference image 62 is an image in which indication position specification information 62A is given to the reference image 60. The indication position specification information 62A refers to information capable of specifying the position indicated by the user 13 as the viewpoint position at which the user 13 observes the inside of the soccer stadium 36, that is, information capable of specifying the position of the target mark 60A inside the reference image 60 (for example, information capable of specifying a position of a pixel corresponding to the center of the target mark 60A inside the reference image 60). The CPU 40A transmits the indication position inclusion reference image 62 to the information processing apparatus 10 via the transmission/reception device 44 (see FIG. 3).

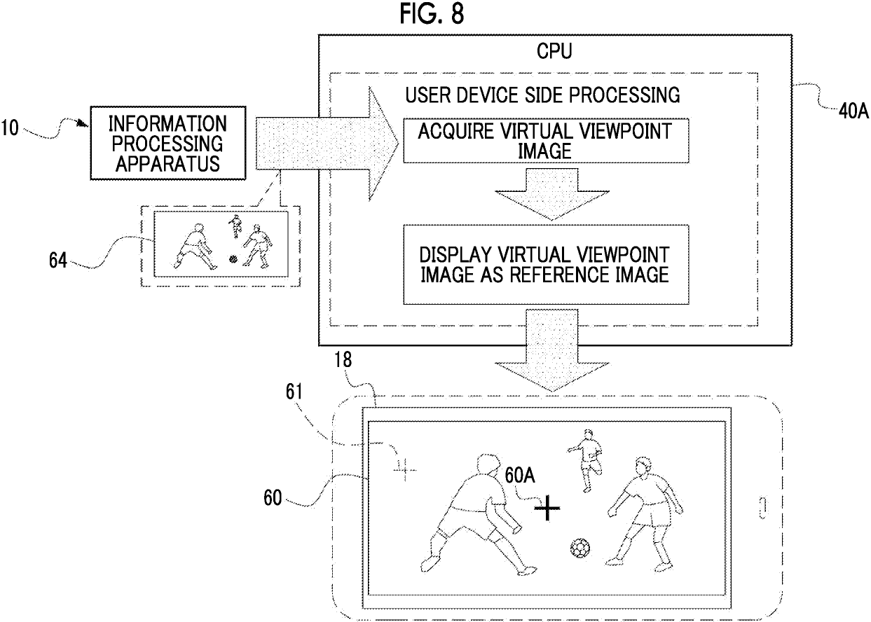

As shown in FIG. 8 as an example, in the user device side processing, the CPU 40A acquires a virtual viewpoint image 64 generated by the information processing apparatus 10. The virtual viewpoint image 64 is a moving image. It should be noted that this is merely an example, and the virtual viewpoint image 64 may be a still image. The CPU 40A displays the acquired virtual viewpoint image 64 on the display 18. Here, the CPU 40A does not simply display the virtual viewpoint image 64 on the display 18, and displays the virtual viewpoint image 64 on the display 18 as a new reference image 60.

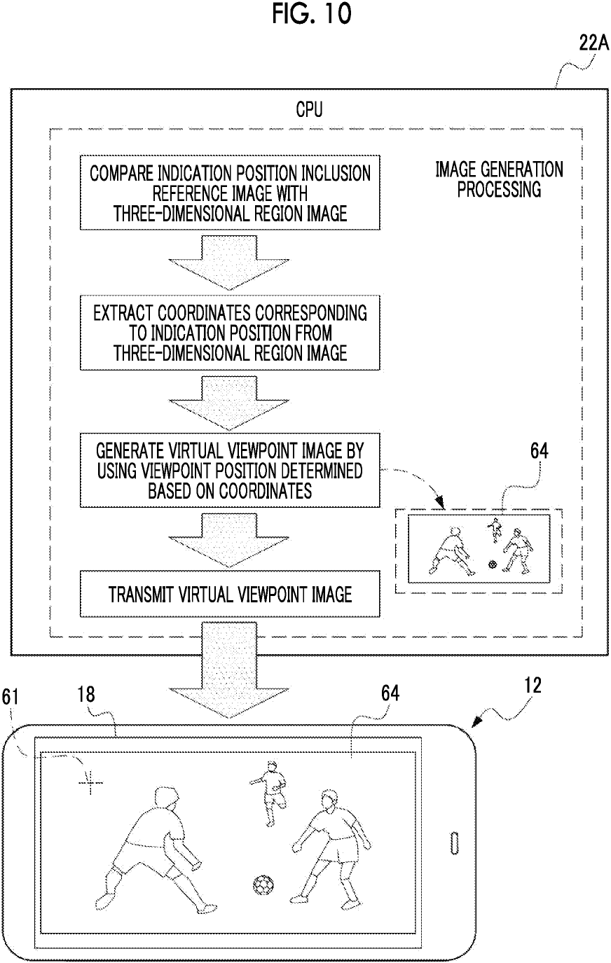

The new reference image 60 is an image based on the virtual viewpoint image 64. That is, here, the new reference image 60 refers to an image in which the target mark 60A is superimposed on the virtual viewpoint image 64. In the example shown in FIG. 8, as the new reference image 60 displayed on the display 18, an image is shown in which the target mark 60A is superimposed on the virtual viewpoint image 64 such that the target mark 60A is positioned at the center of the virtual viewpoint image 64. In addition, as described in detail below, the virtual viewpoint image 64 includes a mark 61 (see FIG. 10) at which a position corresponding to the indication position used for generating the virtual viewpoint image 64 can be specified inside the virtual viewpoint image 64, and the mark 61 is also included in the new reference image 60.

It should be noted that the new reference image 60 is an example of a “designated region image” according to the technology of the present disclosure. The virtual viewpoint image 64 is an example of an “image showing a state of the inside of the three-dimensional region in a case in which the inside of the three-dimensional region is observed in the observation state” according to the technology of the present disclosure. In addition, the position of the target mark 60A superimposed on the virtual viewpoint image 64 is an example of an “indication position” and a “specific position inside the virtual viewpoint image” according to the technology of the present disclosure.

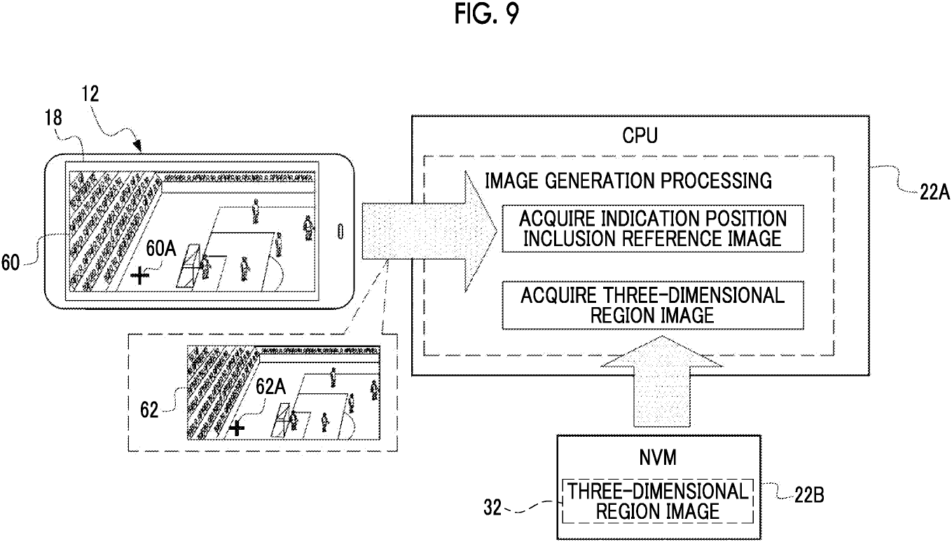

As shown in FIG. 9 as an example, in the image generation processing, the CPU 22A acquires the indication position inclusion reference image 62 from the user device 12. In addition, the CPU 22A acquires the three-dimensional region image 32 from the NVM 22B.

In the image generation processing, the CPU 22A acquires a subject image showing the subject present inside the soccer stadium 36 in a case in which the inside of the soccer stadium 36 is observed from the viewpoint position determined based on the coordinates inside the soccer stadium 36 corresponding to the position of the target mark 60A inside the reference image 60.

In order to realize this, as shown in FIG. 10 as an example, first, the CPU 22A compares the indication position inclusion reference image 62 acquired from the user device 12 with the three-dimensional region image 32 acquired from the NVM 22B to specify a feature point that matches between the indication position inclusion reference image 62 and the three-dimensional region image 32. As a result, a correspondence between the pixel inside the designated indication position inclusion reference image 62 and the pixel inside the three-dimensional region image 32 is specified.

The CPU 22A derives the coordinates inside the soccer stadium 36 corresponding to the indication position from the three-dimensional region image 32 based on the observation state (in the example shown in FIG. 4, the viewpoint position 56, the visual line direction 58, and the angle of view θ) in which the user 13 observes the inside of the soccer stadium 36 and the position (hereinafter, in the first embodiment, this position is also simply referred to as an “indication position”) of the target mark 60A inside the reference image 60.

The observation state in which the user 13 observes the inside of the soccer stadium 36 is determined according to the viewpoint position 56 and is changed according to the displacement of the viewpoint position 56. Since the observation state in which the user 13 observes the inside of the soccer stadium 36 is represented by the indication position inclusion reference image 62, the CPU 22A derives the coordinates inside the soccer stadium 36 corresponding to the indication position from the three-dimensional region image 32 based on a correspondence relationship between the indication position inclusion reference image 62 and the three-dimensional region image 32.

Specifically, the CPU 22A extracts the coordinates of the position corresponding to the indication position from the three-dimensional region image 32 by using a comparison result between the indication position inclusion reference image 62 and the three-dimensional region image 32 (for example, a comparison result indicating which pixel inside the indication position inclusion reference image 62 corresponds to which pixel inside the three-dimensional region image 32).

The CPU 22A generates the virtual viewpoint image 64 by using the viewpoint position determined based on the coordinates extracted from the three-dimensional region image 32. The viewpoint position determined based on the coordinates extracted from the three-dimensional region image 32 refers to, for example, the position inside the soccer stadium 36 specified from the coordinates extracted from the three-dimensional region image 32.

The virtual viewpoint image 64 is a type of the subject image showing the subject present inside the soccer stadium 36 in a case in which the inside of the soccer stadium 36 is observed from the viewpoint position determined based on the coordinates extracted from the three-dimensional region image 32. In this case, the observation state (observation state in which the user 13 virtually observes the inside of the soccer stadium 36), that is, the viewpoint position, the visual line direction, and the angle of view used for generating the virtual viewpoint image 64 are determined by, for example, the viewpoint position determined based on the coordinates extracted from the three-dimensional region image 32, the visual line direction designated in advance by the user 13 or the like, and the angle of view designated in advance by the user 13 or the like.

In addition, in a case in which the indication position specified from the indication position specification information 62A of the indication position inclusion reference image 62 is included in the virtual viewpoint image 64, the CPU 22A gives the mark 61 (in the example shown in FIG. 8, a broken line cross-shaped mark) at which the indication position inside the virtual viewpoint image 64 can be specified to the indication position.

The mark 61 is an example of a “second mark” according to the technology of the present disclosure. In addition, the viewpoint position, the visual line direction, and the angle of view used for generating the virtual viewpoint image 64 are examples of an “observation state” according to the technology of the present disclosure. In addition, a region determined by the viewpoint position, the visual line direction, and the angle of view used for generating the virtual viewpoint image 64 is an example of a “region designated inside the three-dimensional region” according to the technology of the present disclosure. In addition, the viewpoint position used for generating the virtual viewpoint image 64 corresponds to the position at which the user 13 virtually observes the inside of the soccer stadium 36, and is an example of an “observation position” according to the technology of the present disclosure.

Here, as an example of the virtual viewpoint image 64, a moving image using 3D polygons generated based on a plurality of captured images obtained by imaging the inside of the soccer stadium 36 by the plurality of imaging apparatuses 30 is applied. It should be noted that the moving image is merely an example, and may be a still image.

The CPU 22A transmits the virtual viewpoint image 64 to the user device 12 via the transmission/reception device 24 (see FIG. 1). The virtual viewpoint image 64 transmitted in this manner is received by the user device 12, and is displayed on the display 18 as the new reference image 60 (see FIG. 8).

Subsequently, an action of the information processing system 2 will be described.

First, an example of a flow of the user device side processing performed by the CPU 40A of the user device 12 will be described with reference to FIG. 11.

In the user device side processing shown in FIG. 11, first, in step ST10, the CPU 40A acquires the live view image from the imaging apparatus 42, and then the user device side processing shifts to step ST12.

In step ST12, the CPU 40A generates the reference image 60 based on the live view image acquired in step ST10, and then the user device side processing shifts to step ST14.

In step ST14, the CPU 40A displays the reference image 60 generated in step ST12 on the display 18, and then the user device side processing shifts to step ST16.

In step ST16, the CPU 40A determines whether or not the indication position is settled. Here, it is determined that the indication position is settled in a case in which the settlement instruction is received by the touch panel 20, and it is determined that the indication position is not settled in a case in which the settlement instruction is received by the touch panel 20. In step ST16, in a case in which the indication position is not settled, a negative determination is made, and the user device side processing shifts to step ST28. In step ST16, in a case in which the indication position is settled, a positive determination is made, and the user device side processing shifts to step ST18.

In step ST28, the CPU 40A determines whether or not a condition for ending the user device side processing (hereinafter, referred to as a “user device side processing end condition”) is satisfied. A first example of the user device side processing end condition is a condition in which an instruction to end the user device side processing is received by the reception device 50. A second example of the user device side processing end condition is a condition in which a first predetermined time (for example, 60 minutes) has elapsed from the start of the execution of the user device side processing. A third example of the user device side processing end condition is a condition in which the processing capacity of the CPU 40A is reduced to less than a reference level.

In step ST28, in a case in which the user device side processing end condition is not satisfied, a negative determination is made, and the user device side processing shifts to step ST10. In step ST28, in a case in which the user device side processing end condition is satisfied, a positive determination is made, and the user device side processing ends.

In step ST18, the CPU 40A generates the indication position inclusion reference image 62 based on the reference image 60 generated in step ST12 or the reference image 60 in which the target mark 60A is given to the virtual viewpoint image 64 received by the transmission/reception device 44 in step ST20 described below. Then, the CPU 40A transmits the generated indication position inclusion reference image 62 to the information processing apparatus 10 via the transmission/reception device 44. After the processing of step ST18 is executed, the user device side processing shifts to step ST20.

In step ST20, the CPU 40A determines whether or not the virtual viewpoint image 64 transmitted from the information processing apparatus 10 by executing the processing of step ST60 of the image generation processing shown in FIG. 12 is received by the transmission/reception device 44. In step ST20, in a case in which the virtual viewpoint image 64 is not received by the transmission/reception device 44, a negative determination is made, and the determination in step ST20 is made again. In step ST20, in a case in which the virtual viewpoint image 64 is received by the transmission/reception device 44, a positive determination is made, and the user device side processing shifts to step ST22.

In step ST22, the CPU 40A displays, as the new reference image 60, the virtual viewpoint image 64 received by the transmission/reception device 44 in step ST20 on the display 18, and then the user device side processing shifts to step ST24.

In step ST24, the CPU 40A determines whether or not the indication position is settled. In step ST24, in a case in which the indication position is not settled, a negative determination is made, and the user device side processing shifts to step ST26. In step ST24, in a case in which the indication position is settled, a positive determination is made, and the user device side processing shifts to step ST18.

In step ST26, the CPU 40A determines whether or not the user device side processing end condition is satisfied. In step ST26, in a case in which the user device side processing end condition is not satisfied, a negative determination is made, and the user device side processing shifts to step ST24. In step ST26, in a case in which the user device side processing end condition is satisfied, a positive determination is made, and the user device side processing ends.

Subsequently, an example of a flow of the image generation processing performed by the CPU 22A of the information processing apparatus 10 will be described with reference to FIG. 12. The flow of the image generation processing shown in FIG. 12 is an example of an “information processing method” according to the technology of the present disclosure.

In the image generation processing shown in FIG. 12, first, in step ST50, the CPU 22A determines whether or not the indication position inclusion reference image 62 transmitted by executing the processing of step ST18 of the user device side processing shown in FIG. 11 is received by the transmission/reception device 24. In step ST50, in a case in which the indication position inclusion reference image 62 is not received by the transmission/reception device 24, a negative determination is made, and the image generation processing shifts to step ST62. In step ST50, in a case in which the indication position inclusion reference image 62 is received by the transmission/reception device 24, a positive determination is made, and the image generation processing shifts to step ST52.

In step ST52, the CPU 22A acquires the three-dimensional region image 32 from the NVM 22B, and then the image generation processing shifts to step ST54.

In step ST54, the CPU 22A compares the indication position inclusion reference image 62 received by the transmission/reception device 24 in step ST50 with the three-dimensional region image 32 acquired in step ST52, and then the image generation processing shifts to step ST56.

In step ST56, the CPU 22A extracts the coordinates corresponding to the indication position specified from the indication position specification information 62A of the indication position inclusion reference image 62 from the three-dimensional region image 32 by using the comparison result between the indication position inclusion reference image 62 and the three-dimensional region image in step ST54, and then the image generation processing shifts to step ST58.

In step ST58, the CPU 22A generates the virtual viewpoint image 64 by using the viewpoint position determined based on the coordinates extracted in step ST56, and then the image generation processing shifts to step ST60.

In step ST60, the CPU 22A transmits the virtual viewpoint image 64 generated in step ST58 to the user device 12 via the transmission/reception device 24, and then the image generation processing shifts to step ST62.

In step ST62, the CPU 22A determines whether or not a condition for ending the image generation processing (hereinafter, referred to as an “image generation processing end condition”) is satisfied. A first example of the image generation processing end condition is a condition in which an instruction to end the image generation processing is given to the information processing apparatus 10 by a manager or the like of the information processing apparatus 10. A second example of the image generation processing end condition is a condition in which a second predetermined time (for example, 10 hours) has elapsed from the start of the execution of the image generation processing. A third example of the image generation processing end condition is a condition in which the processing capacity of the CPU 22A is reduced to less than a reference level.

In a case in which the image generation processing end condition is not satisfied in step ST62, a negative determination is made, and the image generation processing shifts to step ST50. In a case in which the image generation processing end condition is satisfied, a positive determination is made, and the image generation processing ends.

As described above, in the information processing system 2, the CPU 22A acquires the virtual viewpoint image 64 showing the subject present inside the soccer stadium 36 (see FIG. 4) in a case in which the user 13 virtually observes the inside of the soccer stadium 36 from the viewpoint position determined based on the coordinates inside the soccer stadium 36 corresponding to the indication position that is indicated inside the reference image 60 (see FIG. 6) showing the state of the inside of the soccer stadium 36 in a case in which the user 13 observes the inside of the soccer stadium 36 from the viewpoint position 56 (see FIG. 4). The virtual viewpoint image 64 acquired by the CPU 22A is displayed on the display 18 of the user device 12. Therefore, with the present configuration, it is possible to cause the user 13 to observe the state inside the soccer stadium 36 from various positions.

In addition, in the information processing system 2, the CPU 22A derives the coordinates inside the soccer stadium 36 corresponding to the indication position based on the observation state in which the user 13 observes the inside of the soccer stadium 36, and the indication position. Therefore, with the present configuration, it is possible to specify which position inside the soccer stadium 36 the position indicated by the user 13 is.

In addition, in the information processing system 2, the observation state in which the user 13 observes the inside of the soccer stadium 36 is determined according to the position at which the user 13 observes the inside of the soccer stadium 36 inside the real space or inside the virtual space. Therefore, in a case in which the position at which the user 13 observes the inside of the soccer stadium 36 is displaced, the observation state in which the user 13 observes the inside of the soccer stadium 36 is also changed accordingly. In this case as well, the CPU 22A derives the coordinates inside the soccer stadium 36 corresponding to the indication position based on the observation state in which the user 13 observes the inside of the soccer stadium 36, and the indication position. Therefore, with the present configuration, even in a case in which the observation state is changed with the displacement of the position at which the user 13 observes the inside of the soccer stadium 36, it is possible to specify which position inside the soccer stadium 36 the position indicated by the user 13 is.

In addition, in the information processing system 2, the CPU 22A derives the coordinates inside the soccer stadium 36 corresponding to the indication position based on the correspondence relationship between the live view image or the virtual viewpoint image 64 and the three-dimensional region image 32. Therefore, with the present configuration, it is possible to specify which position inside the soccer stadium 36 the position indicated by the user 13 is, with higher accuracy, than in a case of inferring which position inside the soccer stadium 36 the position indicated by the user 13 is, based only on the information obtained by visual observation from the live view image or the virtual viewpoint image 64, and the human intuition.

In addition, in the information processing system 2, the image based on the live view image and the image based on the virtual viewpoint image 64 are used as the reference image 60. Therefore, with the present configuration, the user 13 can indicate the viewpoint position while confirming the state inside the real space, or can indicate the viewpoint position while confirming the state inside the virtual space.

In addition, in the information processing system 2, the position of the target mark 60A inside the live view image or inside the virtual viewpoint image 64 is the position indicated by the user 13. The position of the target mark 60A is changed in response to the change instruction (see FIG. 6) given by the user 13, and is settled in response to the settlement instruction (see FIG. 7) given by the user 13. Therefore, with the present configuration, it is possible to set the position intended by the user 13 as the viewpoint position.

In addition, in the information processing system 2, the target mark 60A is used as the mark at which the indication position inside the reference image 60 can be specified, and the target mark 60A is displayed on the display 18 of the user device 12 in a state in which the target mark 60A is included in the reference image 60. Therefore, with the present configuration, it is possible to cause the user 13 to visually recognize the indication position on the reference image 60.

In addition, in the information processing system 2, the mark 61 is included in the virtual viewpoint image 64. The mark 61 is a mark at which the indication position used for generating the virtual viewpoint image 64 can be specified inside the virtual viewpoint image 64. Therefore, with the present configuration, it is possible to cause the user 13 to infer the indication position used for generating the virtual viewpoint image 64 from the virtual viewpoint image 64.

In addition, in the information processing system 2, the coordinates related to the position of the soccer field 36A indicated by the three-dimensional region image 32 are the coordinates indicating the position higher than the actual position of the soccer field 36A. Therefore, with the present configuration, it is possible to prevent the viewpoint position from being set on the ground of the soccer field 36A.

Further, in the information processing system 2, the indication position is detected by the CPU 22A based on the reference image 60. That is, the position of the target mark 60A is detected by the CPU 22A as the indication position. Therefore, with the present configuration, it is possible to specify the indication position with higher accuracy than in a case of inferring the indication position based only on the information obtained by visual observation from the live view image or the virtual viewpoint image 64, and the human intuition.

It should be noted that, in the first embodiment, the form example has been described in which, in the image generation processing, the CPU 22A generates the virtual viewpoint image 64 and transmits the virtual viewpoint image 64 to the user device 12, but the technology of the present disclosure is not limited to this. For example, in a case in which the imaging apparatus 30 is installed at a position that matches the viewpoint position determined based on the coordinates extracted from the three-dimensional region image 32, the captured image obtained by the imaging with the imaging apparatus 30 installed at a position that matches the viewpoint position determined based on the coordinates extracted from the three-dimensional region image 32 may be transmitted to the user device 12 from the information processing apparatus 10, as an alternative image of the virtual viewpoint image 64.

In addition, in the first embodiment, the form example has been described in which the CPU 22A generates the new virtual viewpoint image 64 and transmits the generated new virtual viewpoint image 64 to the user device 12 each time the indication position inclusion reference image 62 is acquired, but the technology of the present disclosure is not limited to this. For example, in a case in which an object image showing an object present inside the soccer stadium 36 in a case in which the inside of the soccer stadium 36 is observed from a position within a range in which a distance from the indication position specified from the indication position specification information 62A of the indication position inclusion reference image 62 is equal to or less than a threshold value is stored in a storage region, the CPU 22A may acquire the object image from the storage region and transmit the acquired object image to the user device 12.

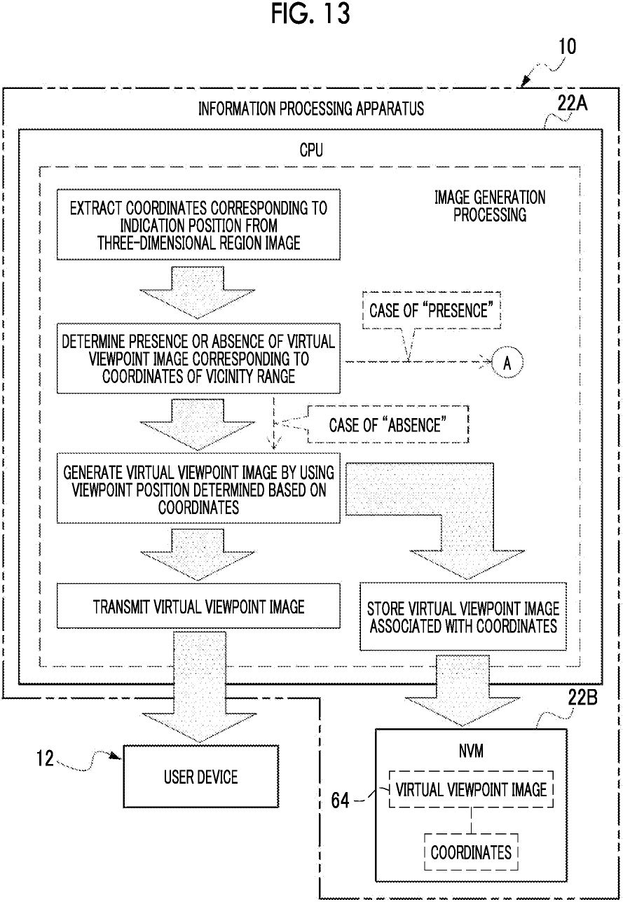

In this case, as shown in FIG. 13 as an example, as in the first embodiment, the CPU 22A extracts the coordinates corresponding to the indication position specified from the indication position specification information 62A of the indication position inclusion reference image 62 from the three-dimensional region image 32. Then, the CPU 22A determines whether or not the virtual viewpoint image 64 associated with the coordinates within a vicinity range of the coordinates extracted from the three-dimensional region image 32 is stored in the NVM 22B. Here, the vicinity range refers to a range within a radius of 2 meters, for example. Moreover, the radius of 2 meters is an example of a “threshold value” according to the technology of the present disclosure. Moreover, the NVM 22B is an example of a “storage region” according to the technology of the present disclosure. Also, the virtual viewpoint image 64 is an example of an “object image” according to the technology of the present disclosure, and the object indicated by the virtual viewpoint image 64 is an example of an “object” according to the technology of the present disclosure.

In a case in which the virtual viewpoint image 64 associated with the coordinates within the vicinity range of the coordinates extracted by the CPU 22A from the three-dimensional region image 32 is not stored in the NVM 22B, as in the first embodiment, the CPU 22A generates the virtual viewpoint image 64, and transmits the generated virtual viewpoint image 64 to the user device 12 via the transmission/reception device 24. In addition, the CPU 22A associates the generated virtual viewpoint image 64 with the coordinates extracted from the three-dimensional region image 32, and stores the virtual viewpoint image 64 associated with the coordinates in the NVM 22B.

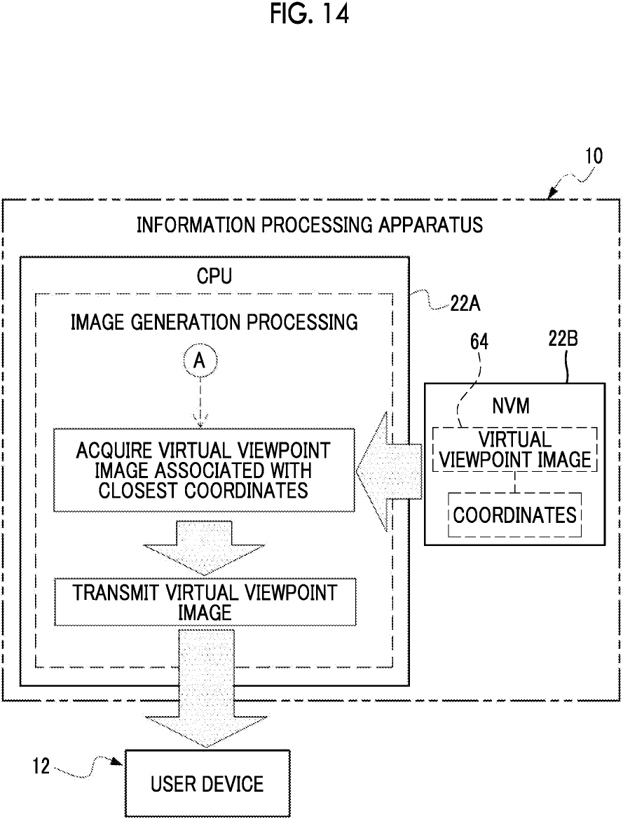

On the other hand, in a case in which the virtual viewpoint image 64 associated with the coordinates within the vicinity range of the coordinates extracted by the CPU 22A from the three-dimensional region image 32 is stored in the NVM 22B, as shown in FIG. 14 as an example, the CPU 22A acquires the virtual viewpoint image 64 associated with the coordinates closest to the coordinates extracted from the three-dimensional region image 32, from the NVM 22B. Then, the CPU 22A transmits the virtual viewpoint image 64 acquired from the NVM 22B to the user device 12 via the transmission/reception device 24. As a result, it is possible to more quickly provide the virtual viewpoint image 64 to the user 13 than in a case in which the new virtual viewpoint image 64 is generated each time the CPU 22A acquires the indication position inclusion reference image 62.

In the examples shown in FIGS. 13 and 14, the form example has been described in which the virtual viewpoint image 64 is generated, and is transmitted to the user device 12 or stored in the NVM 22B, but the technology of the present disclosure is not limited to this, and the captured image may be transmitted to the user device 12 or stored in the NVM 22B, together with the virtual viewpoint image 64 or instead of the virtual viewpoint image 64.

### Second Embodiment

In the first embodiment, the case has been described in which the user 13 virtually observes the inside of the soccer stadium 36 from the viewpoint position determined based on the coordinates inside the soccer stadium 36 corresponding to the position indicated inside the reference image 60. However, in the second embodiment, a case will be described in which the user 13 virtually observes the inside of the soccer stadium 36 from the viewpoint position determined based on the coordinates inside the soccer stadium 36 corresponding to the position indicated inside the soccer stadium 36, which is the observation target. It should be noted that, in the second embodiment, the same components as the components in the first embodiment will be designated by the same reference numeral, the description thereof will be omitted, and a difference from the first embodiment will be described.

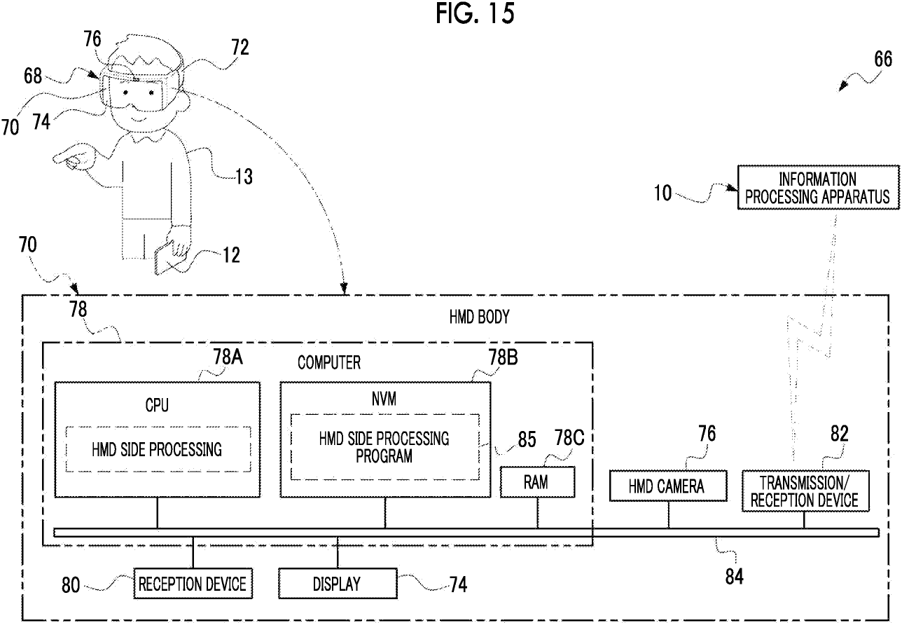

As shown in FIG. 15 as an example, an information processing system 66 comprises the information processing apparatus 10, the user device 12, and an HMD 68.

The HMD 68 comprises an HMD body 70 and a band 72. The band 72 is a stretchable member formed in a band shape from one end to the other end of the HMD body 70. An outer shape of the HMD 68 is formed in an annular shape by the HMD body 70 and the band 72, and the HMD 68 is fixed to be closely attached with the upper half of the head of the user 13.

The HMD body 70 includes a display 74, an HMD camera 76, a computer 78, a reception device 80, and a transmission/reception device 82. The display 74 has a screen (not shown) and a projection unit (not shown). The screen is made of a transparent material, and the user 13 visually recognizes the real space via the screen. That is, the HMD 68 is a transmission type HMD. It should be noted that the HMD body 70 does not necessarily have to comprise the computer 78, and the computer 78 may be provided separately from the HMD body 70. In that case, the HMD body 70 may have only a function of displaying data received from the computer 78 via the transmission/reception device 82 and transmitting data related to the image obtained by imaging with the HMD camera 76 to the computer 78. In addition, the HMD camera 76 may also be provided separately from the HMD body 70. For example, the HMD camera 76 may be a camera that can be attached to and detached from the HMD body 70.

The screen is positioned to face the eyes of the user 13, and an image is projected onto an inner surface (surface on the user 13 side) of the screen by the projection unit. Since the projection unit is a well-known device, the detailed description thereof will be omitted. However, the projection unit is a device including a display element, such as a liquid crystal, which displays the image, and a projection optical system that projects the image displayed on the display element toward the inner surface of the screen. The screen is realized by a half mirror that reflects the image projected by the projection unit and transmits light in the real space. The projection unit projects the image onto the inner surface of the screen at a predetermined frame rate (for example, 60 frames/second). The image is reflected by the inner surface of the screen and is incident on the eyes of the user 13. As a result, the user 13 visually recognizes the image.

The HMD camera 76 is an imaging device including a CMOS image sensor, and has an optical zoom function and/or a digital zoom function. It should be noted that, instead of the CMOS image sensor, another type of image sensor, such as a CCD image sensor, may be adopted. The HMD camera 76 is positioned in front of the forehead of the user 13 and images the front of the user 13.

The computer 78 comprises a CPU 78A, an NVM 78B, and a RAM 78C, and the CPU 78A, the NVM 78B, and the RAM 78C are connected to each other via a bus 84. In the example shown in FIG. 15, one bus is shown as the bus 84 for convenience of illustration, but a plurality of buses may be used. In addition, the bus 84 may include a serial bus or a parallel bus configured by a data bus, an address bus, a control bus, and the like.

The CPU 78A controls the entire HMD body 70. Various parameters and various programs are stored in the NVM 78B. Examples of the NVM 78B include an EEPROM. Various types of information are transitorily stored in the RAM 78C. The RAM 78C is used as a work memory by the CPU 78A.

The display 74 is connected to the bus 84. Specifically, the projection unit described above is connected to the bus 84. The display 74 displays various types of information under the control of the CPU 78A.

The HMD camera 76 is connected to the bus 84, and the CPU 78A controls the HMD camera 76. The captured image obtained by the imaging with the HMD camera 76 is acquired by the CPU 78A via the bus 84.

The transmission/reception device 82 is connected to the bus 84. The transmission/reception device 82 is a device including a communication processor (not shown), an antenna, and the like, and transmits and receives various types of information to and from the information processing apparatus 10 via the base station (not shown) under the control of the CPU 78A. That is, the CPU 78A exchanges various types of information with the information processing apparatus 10 via the transmission/reception device 82.

The reception device 80 is a device including at least one hard key and receives an instruction from the user 13. The reception device 80 is connected to the bus 84, and an instruction received by the reception device 80 is acquired by the CPU 78A.

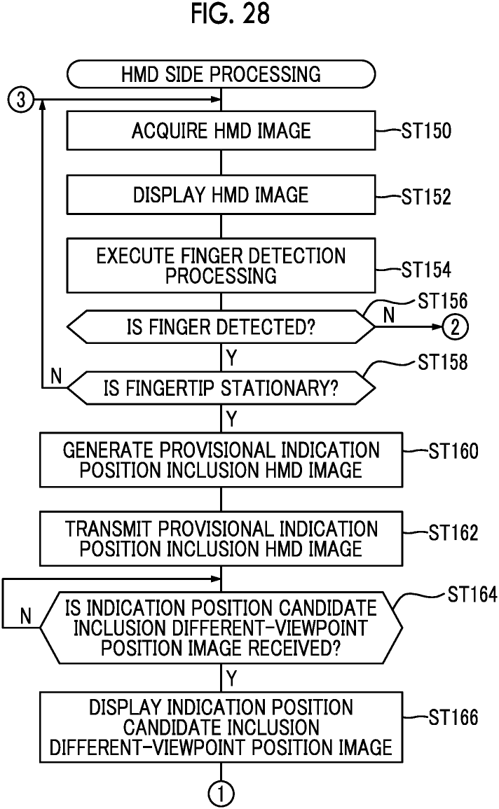

The NVM 78B stores an HMD side processing program 85. The CPU 78A performs HMD side processing (see FIG. 28) by reading out the HMD side processing program 85 from the NVM 78B and executing the HMD side processing program 85 on the RAM 78C.

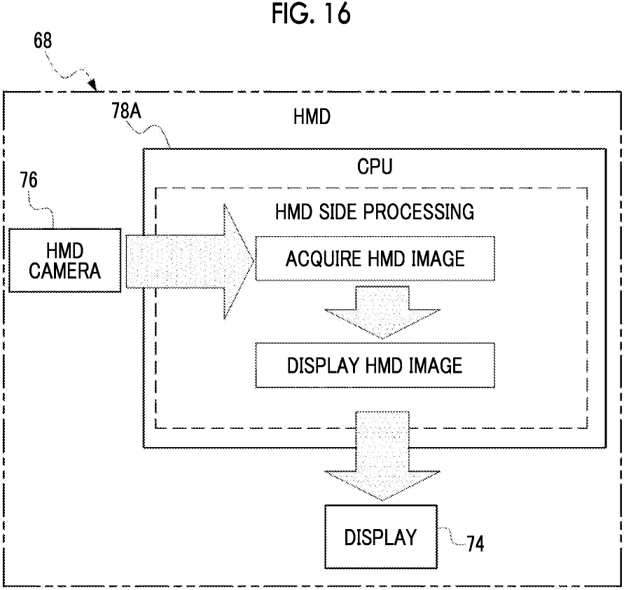

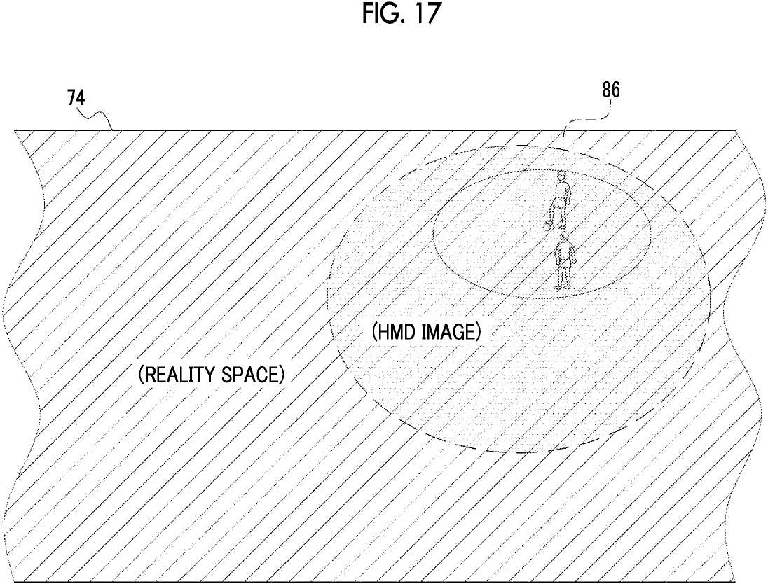

As shown in FIG. 16 as an example, in the HMD side processing, the CPU 78A acquires an HMD image 86 (see FIG. 17) from the HMD camera 76. The HMD image 86 is the live view image, for example. The CPU 78A displays the HMD image 86 on the display 74.

As shown in FIG. 17 as an example, the user 13 can observe the reality space via the entire display 74. The HMD image 86 is displayed on the display 74. The HMD image 86 is displayed in a state of being superimposed on a part of a reality space region by the user 13 via the display 74. Since the light in the reality space is also transmitted through a display region of the HMD image 86, the user 13 can observe the reality space via the display region of the HMD image 86.

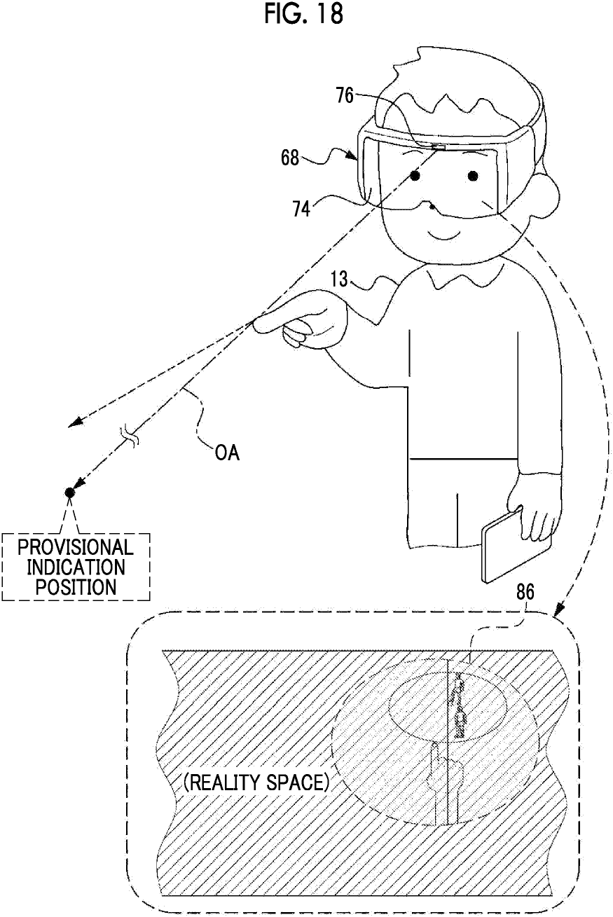

As shown in FIG. 18 as an example, in a case in which the finger of the user 13 enters the angle of view of the HMD camera 76, the finger of the user is captured by the HMD camera 76 and projected as the image inside the HMD image 86. By pointing the finger within the angle of view of the HMD camera 76, the user 13 provisionally indicates the position pointed to by the finger as the viewpoint position at which the user 13 observes the inside of the soccer stadium 36. It should be noted that, since the direction in which the finger is actually pointed deviates from the visual line direction of the user 13, a destination pointed to by the finger is not a position intended by the user 13 as the viewpoint position. The position intended by the user 13 as the viewpoint position is a destination of the visual line passing through a fingertip of the user 13. The direction of an optical axis OA of the imaging optical system of the HMD camera 76 substantially matches the visual line direction of the user 13. Therefore, in the information processing system 66, a position in contact with the optical axis OA inside the soccer stadium 36 in a case in which the center of the angle of view and the position of the fingertip of the user 13 match, that is, one point (gaze point) gazed by the user 13 who currently observes the inside of the soccer stadium 36 is used as a position (hereinafter, also referred to as a “provisional indication position”) that is provisionally indicated by the user 13 as the viewpoint position at which the user 13 observes the inside of the soccer stadium 36.

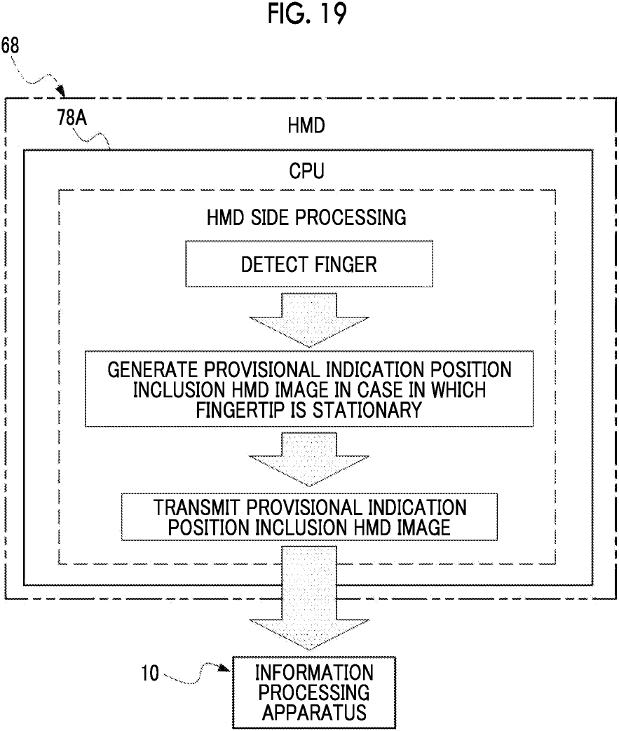

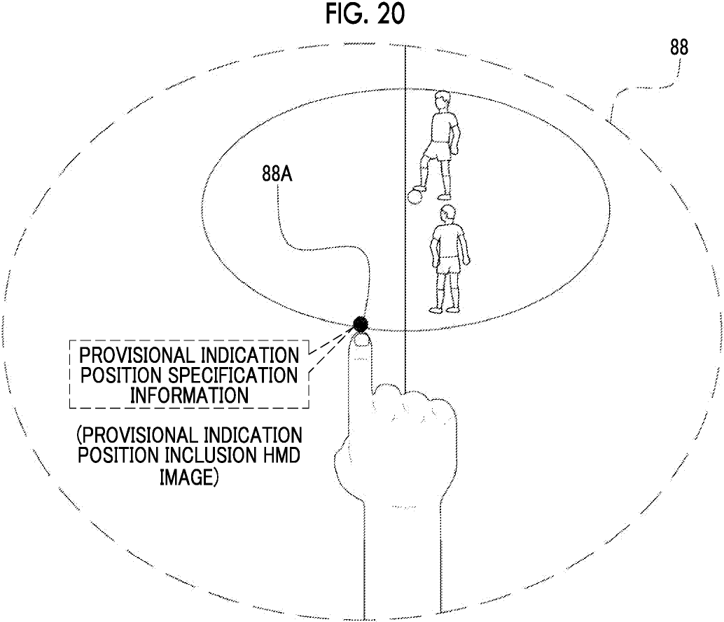

As shown in FIG. 19 as an example, in the HMD side processing, the CPU 78A detects the finger of the user 13 by using the HMD image 86 obtained by the imaging with the HMD camera 76. The CPU 78A generates a provisional indication position inclusion HMD image 88 (see FIG. 20) in a case in which the fingertip of the user 13 is stationary at the center of the angle of view. A case in which the fingertip of the user 13 is stationary at the center of the angle of view means, for example, a case in which a state in which the fingertip of the user 13 is stationary at the center of the angle of view is continued for a time (for example, 3 seconds) designated in advance. The CPU 78A transmits the generated provisional indication position inclusion HMD image 88 to the information processing apparatus 10 via the transmission/reception device 82 (see FIG. 15).

As shown in FIG. 20 as an example, the provisional indication position inclusion HMD image 88 is an image in which provisional indication position specification information 88A is given to the HMD image 86. The provisional indication position specification information 88A refers to information capable of specifying the provisional indication position inside the HMD image 86 (for example, information capable of specifying a position of a pixel corresponding to the provisional indication position inside the HMD image 86, that is, a position of a pixel corresponding to the position of the fingertip shown inside the HMD image 86).

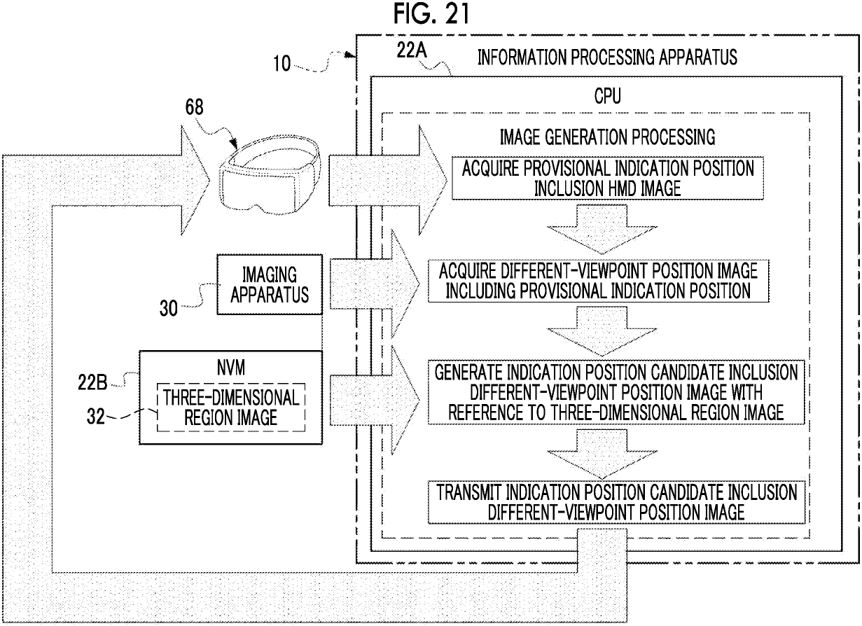

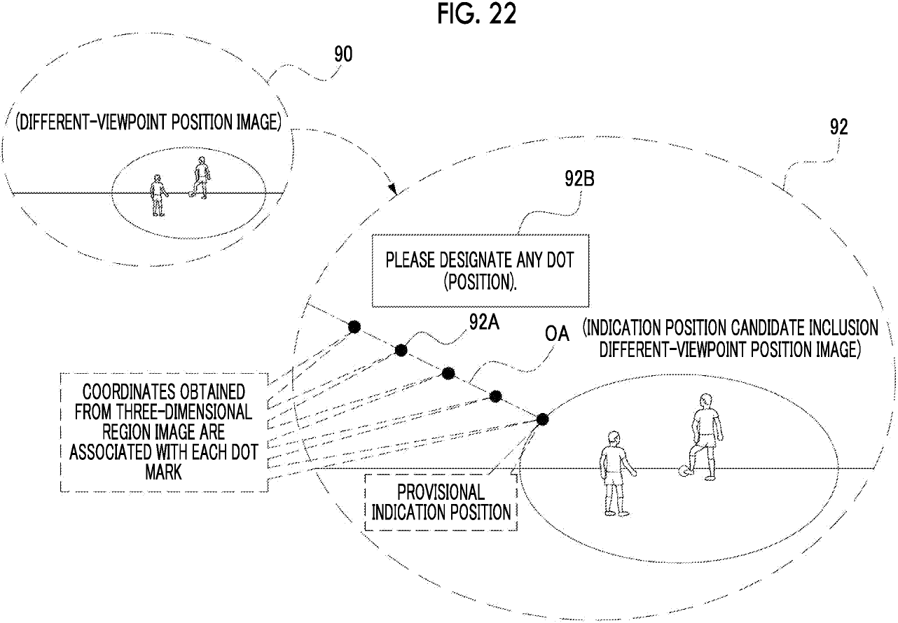

As shown in FIG. 21 as an example, in the image generation processing of the information processing apparatus 10, the CPU 22A acquires the provisional indication position inclusion HMD image 88 from the HMD 68. The CPU 22A acquires, from the imaging apparatus 30, the captured image showing the subject including the provisional indication position specified from the provisional indication position specification information 88A of the provisional indication position inclusion HMD image 88 as a different-viewpoint position image 90 (see FIG. 22) showing the state of the inside of the soccer stadium 36 in a case in which the inside of the soccer stadium 36 is observed from the viewpoint position different from the current viewpoint position of the user 13.

The CPU 22A acquires the three-dimensional region image 32 from the NVM 22B, and generates an indication position candidate inclusion different-viewpoint position image 92 (see FIG. 22) with reference to the acquired three-dimensional region image 32. Specifically, first, the CPU 22A specifies the position of the optical axis OA inside the soccer stadium 36 by specifying the feature point that matches between the provisional indication position inclusion HMD image 88 and the three-dimensional region image 32. Next, the CPU 22A compares the provisional indication position inclusion HMD image 88 with the three-dimensional region image 32, and extracts the coordinates of the provisional indication position inside the soccer stadium 36 from the three-dimensional region image 32 based on a comparison result. Subsequently, the CPU 22A generates a plurality of indication position candidates. The plurality of indication position candidates are positions determined by a predetermined interval (for example, an interval of 5 meters on a real space scale) on the optical axis OA including the provisional indication position. Coordinates obtained from the three-dimensional region image 32 are associated with each of the plurality of indication position candidates. Then, the CPU 22A gives information, such as a plurality of indication position candidates, to the different-viewpoint position image 90 to generate the indication position candidate inclusion different-viewpoint position image 92 (see FIG. 22). The CPU 22A transmits the indication position candidate inclusion different-viewpoint position image 92 to the HMD 68 via the transmission/reception device 24 (see FIG. 1).

It should be noted that the optical axis OA is an example of a “first line” according to the technology of the present disclosure, and the provisional indication position is an example of a “gaze point” according to the technology of the present disclosure.

As shown in FIG. 22 as an example, the indication position candidate inclusion different-viewpoint position image 92 is an image in which a plurality of dot marks 92A and a message 92B are superimposed on the different-viewpoint position image 90. The plurality of dot marks 92A are arranged at a predetermined interval on the image showing the optical axis OA, and each dot mark 92A is a mark at which the indication position candidate can be specified. It should be noted that the image showing the optical axis OA does not necessarily have to be displayed, and the image showing the optical axis OA may not be displayed.

Each dot mark 92A is associated with the coordinates obtained from the three-dimensional region image 32 as the coordinates at which the position of the indication position candidate can be specified. The message 92B is a message prompting the user 13 to select the indication position candidate, and in the example shown in FIG. 22, as an example of the message 92B, a message “Please designate any dot (position)” is shown.

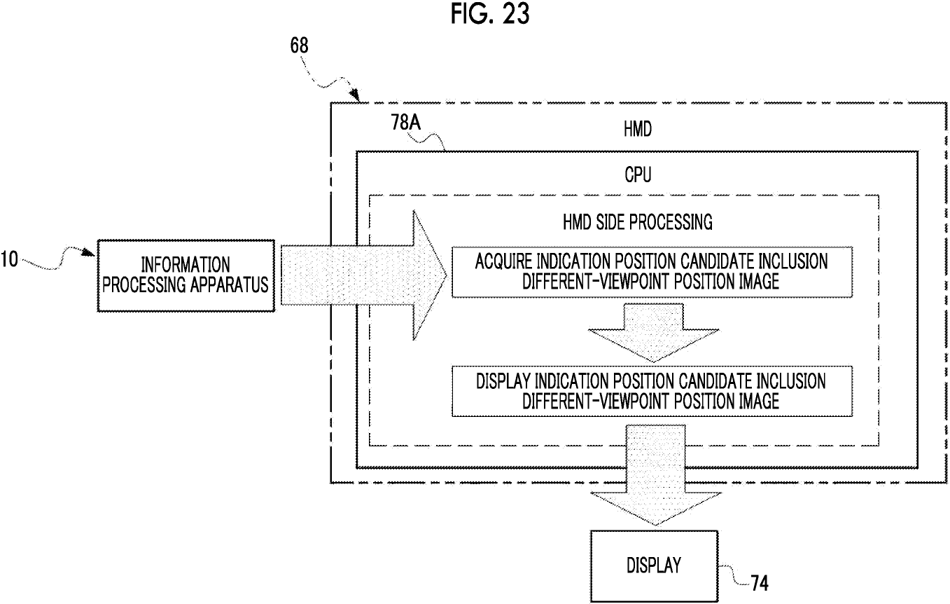

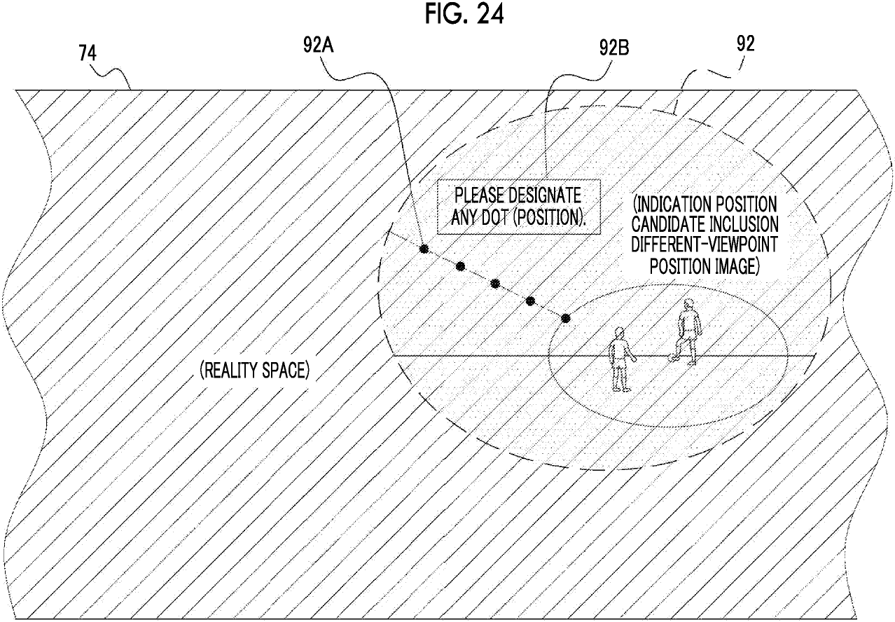

As shown in FIG. 23 as an example, in the HMD side processing, the CPU 78A acquires the indication position candidate inclusion different-viewpoint position image 92 from the information processing apparatus 10. Then, as shown in FIG. 24 as an example, the CPU 78A displays the indication position candidate inclusion different-viewpoint position image 92 on the display 74.

By positioning the fingertip at any dot mark 92A of the plurality of dot marks 92A included in the indication position candidate inclusion different-viewpoint position image 92, the user 13 indicates the observation position intended by the user 13 with respect to the inside of the soccer stadium 36. That is, the observation position intended by the user 13 is decided by the user 13 indicating the plurality of indication position candidates given on the optical axis OA. It should be noted that, here, the observation position intended by the user 13 is an example of an “indication position”, an “observation position”, and a “position indicated on a first line” according to the technology of the present disclosure.

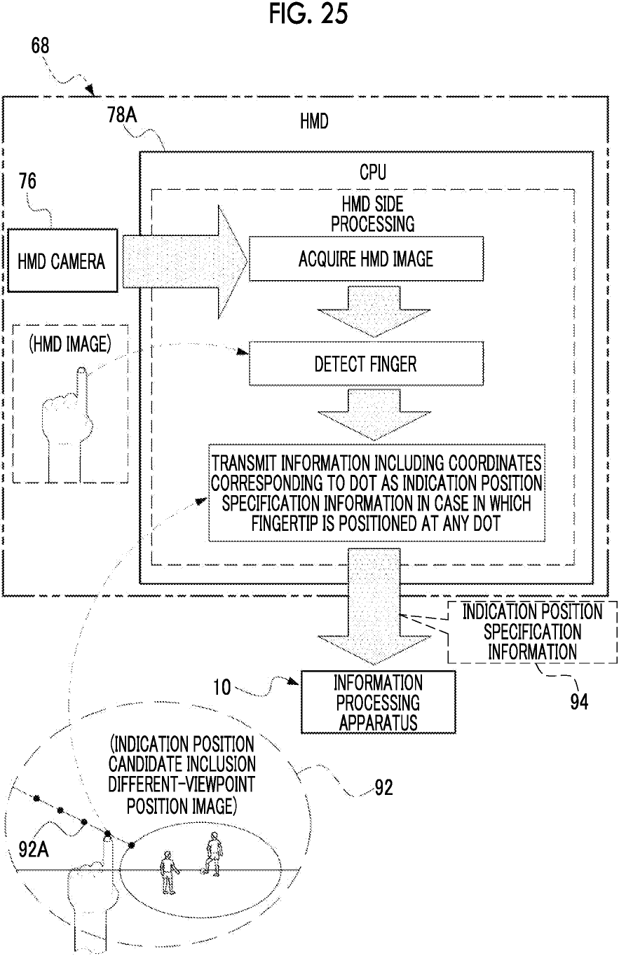

As shown in FIG. 25 as an example, in the HMD side processing, the CPU 78A acquires the HMD image 86 from the HMD camera 76, and detects the finger of the user 13 by using the acquired HMD image 86. In a case in which the fingertip of the user 13 is positioned at any of the dot marks 92A, the CPU 78A transmits the information including the coordinates associated with the dot mark 92A at which the fingertip of the user 13 is positioned, to the information processing apparatus 10 via the transmission/reception device 82 (see FIG. 15), as indication position specification information 94. The indication position specification information 94 is information capable of specifying the indication position candidate selected by the user 13 via the dot mark 92A, that is, information capable of specifying the position indicated by the user 13 as the viewpoint position at which the user 13 observes the inside of the soccer stadium 36.

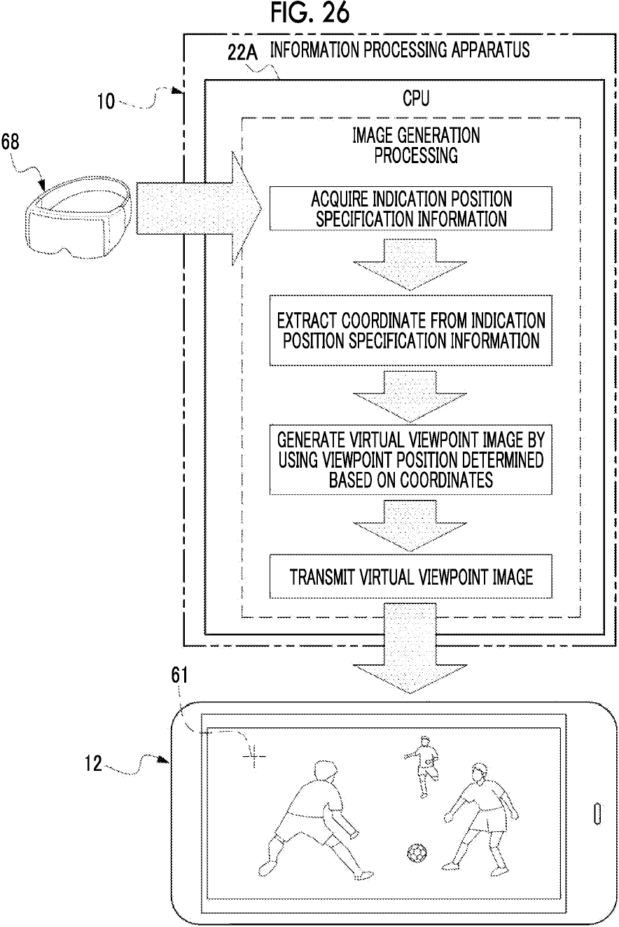

As shown in FIG. 26 as an example, in the image generation processing of the information processing apparatus 10, the CPU 22A acquires the indication position specification information 94 from the HMD 68. The CPU 22A extracts the coordinates from the indication position specification information 94 and generates the virtual viewpoint image 64 (see FIG. 10) by using the viewpoint position determined based on the extracted coordinates. The CPU 22A transmits the generated virtual viewpoint image 64 to the user device 12 via the transmission/reception device 24. As a result, as in the first embodiment, the user device 12 displays the virtual viewpoint image 64 on the display 18.

It should be noted that, here, the form example has been described in which the virtual viewpoint image 64 is transmitted to the user device 12, the technology of the present disclosure is not limited to this, and the virtual viewpoint image 64 may be transmitted to the HMD 68 and the virtual viewpoint image 64 may be displayed on the display 74 of the HMD 68.

Subsequently, an action of the information processing system 66 will be described.

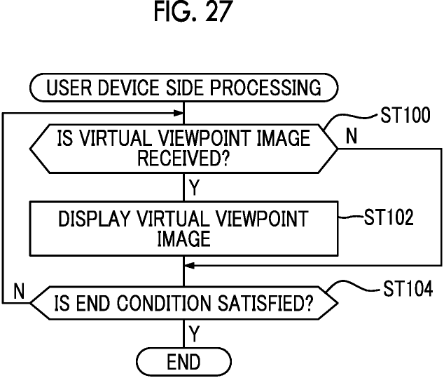

First, an example of a flow of the user device side processing performed by the CPU 40A of the user device 12 will be described with reference to FIG. 27.

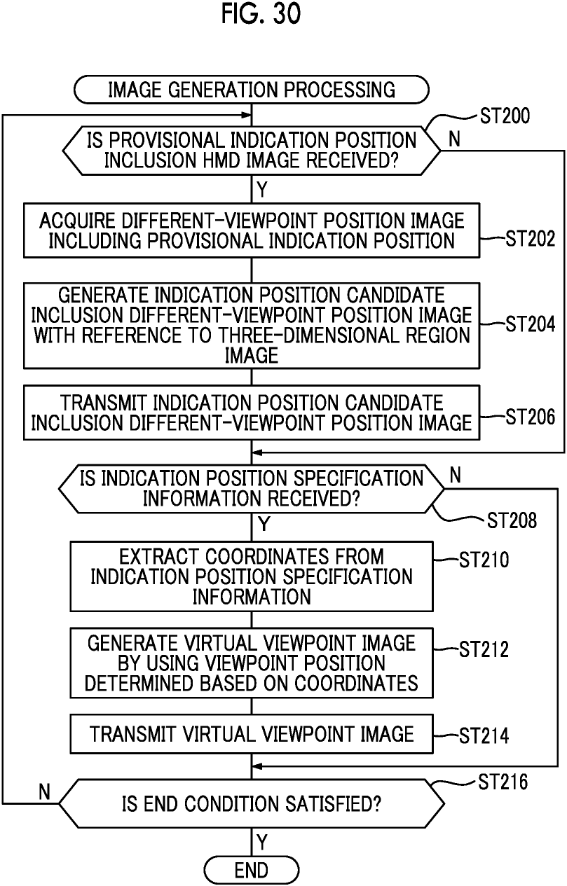

In the example shown in FIG. 27, first, in step ST100, the CPU 40A determines whether or not the virtual viewpoint image 64 transmitted by executing the processing of step ST214 of the image generation processing shown in FIG. 30 is received by the transmission/reception device 44. In step ST100, in a case in which the virtual viewpoint image 64 is not received by the transmission/reception device 44, a negative determination is made, and the user device side processing shifts to step ST104. In step ST100, in a case in which the virtual viewpoint image 64 is received by the transmission/reception device 44, a positive determination is made, and the user device side processing shifts to step ST102.

In step ST102, the CPU 40A displays the virtual viewpoint image 64 received by the transmission/reception device 44 in step ST100 on the display 18, and then the user device side processing shifts to step ST104.

In step ST104, the CPU 40A determines whether or not the user device side processing end condition is satisfied. In step ST104, in a case in which the user device side processing end condition is not satisfied, a negative determination is made, and the user device side processing shifts to step ST100. In step ST104, in a case in which the user device side processing end condition is satisfied, a positive determination is made, and the user device side processing ends.

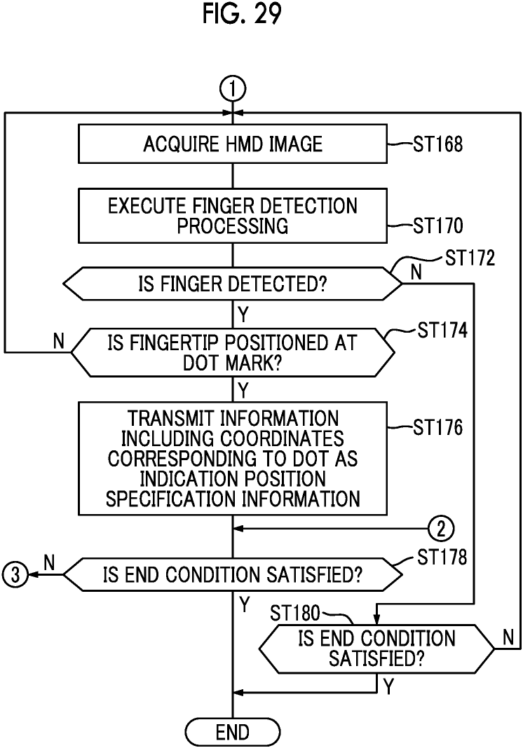

Next, an example of a flow of the HMD side processing performed by the CPU 78A of the HMD 68 will be described with reference to FIGS. 28 and 29.

In the HMD side processing shown in FIG. 28, first, in step ST150, the CPU 78A acquires the HMD image 86 from the HMD camera 76, and then the HMD side processing shifts to step ST152.

In step ST152, the CPU 78A displays the HMD image 86 acquired in step ST150 on the display 74, and then the HMD side processing shifts to step ST154.

In step ST154, the CPU 78A executes finger detection processing by using the HMD image 86 acquired in step ST152. The finger detection processing refers to processing of detecting the finger of the user 13 by using the HMD image 86. After the processing of step ST154 is executed, the HMD side processing shifts to step ST156.

In step ST156, the CPU 78A determines whether or not the finger of the user 13 is detected by the finger detection processing of step ST154. In step ST156, in a case in which the finger of the user 13 is not detected by the finger detection processing of step ST154, a negative determination is made, and the processing shifts to step ST178 shown in FIG. 29. In step ST156, in a case in which the finger of the user 13 is detected by the finger detection processing of step ST154, a positive determination is made, and the HMD side processing shifts to step ST158.

In step ST158, the CPU 78A determines whether or not the fingertip of the user 13 is stationary at the center of the angle of view of the HMD camera 76. In step ST158, in a case in which the fingertip of the user 13 is not stationary at the center of the angle of view of the HMD camera 76, a negative determination is made, and the HMD side processing shifts to step ST150. In step ST158, in a case in which the fingertip of the user 13 is stationary at the center of the angle of view of the HMD camera 76, a positive determination is made, and the HMD side processing shifts to step ST160.

In step ST160, the CPU 78A generates the provisional indication position inclusion HMD image 88 based on the HMD image 86 acquired in step ST150, and then the HMD side processing shifts to step ST162.

In step ST162, the CPU 78A transmits the provisional indication position inclusion HMD image 88 generated in step ST160 to the information processing apparatus 10 via the transmission/reception device 82, and then the HMD side processing shifts to step ST164.

In step ST164, the CPU 78A determines whether or not the indication position candidate inclusion different-viewpoint position image 92 transmitted by executing the processing of step ST206 shown in FIG. 30 is received by the transmission/reception device 82. In step ST164, in a case in which the indication position candidate inclusion different-viewpoint position image 92 is not received by the transmission/reception device 82, a negative determination is made, and the determination in step ST164 is made again. In step ST164, in a case in which the indication position candidate inclusion different-viewpoint position image 92 is received by the transmission/reception device 82, a positive determination is made, and the HMD side processing shifts to step ST166.

In step ST166, the CPU 78A displays the indication position candidate inclusion different-viewpoint position image 92 received by the transmission/reception device 82 in step ST164 on the display 74, and then the HMD side processing shifts to step ST168 shown in FIG. 29.

In step ST168 shown in FIG. 29, the CPU 78A acquires the HMD image 86 from the HMD camera 76, and then the HMD side processing shifts to step ST170.

In step ST170, the CPU 78A executes the finger detection processing by using the HMD image 86 acquired in step ST168, and then the HMD side processing shifts to step ST172.

In step ST172, the CPU 78A determines whether or not the finger of the user 13 is detected by the finger detection processing of step ST170. In step ST172, in a case in which the finger of the user 13 is not detected by the finger detection processing of step ST170, a negative determination is made, and the processing shifts to step ST180. In step ST172, in a case in which the finger of the user 13 is detected by the finger detection processing of step ST170, a positive determination is made, and the HMD side processing shifts to step ST174.

In step ST180, the CPU 78A determines whether or not a condition for ending the HMD side processing (hereinafter, referred to as an “HMD side processing end condition”) is satisfied. A first example of the HMD side processing end condition is a condition in which an instruction to end the HMD side processing is received by the reception device 80. A second example of the HMD side processing end condition is a condition in which a third predetermined time (for example, 60 minutes) has elapsed from the start of the execution of the HMD side processing. A third example of the HMD side processing end condition is a condition in which the processing capacity of the CPU 78A is reduced to less than a reference level.

In step ST180, in a case in which the HMD side processing end condition is not satisfied, a negative determination is made, and the HMD side processing shifts to step ST168. In step ST180, in a case in which the HMD side processing end condition is satisfied, a positive determination is made, and the HMD side processing ends.

In step ST174, the CPU 78A determines whether or not the tip of the finger (fingertip of the user 13) detected in step ST172 is positioned at the dot mark 92A on the indication position candidate inclusion different-viewpoint position image 92 displayed on the display 74. In step ST174, in a case in which the fingertip of the user 13 is not positioned at the dot mark 92A on the indication position candidate inclusion different-viewpoint position image 92, a negative determination is made, and the HMD side processing shifts to step ST168. In step ST174, in a case in which the fingertip of the user 13 is positioned at the dot mark 92A on the indication position candidate inclusion different-viewpoint position image 92, a positive determination is made, and the HMD side processing shifts to step ST176.

In step ST176, the CPU 78A transmits the information including the coordinates associated with the dot mark 92A at which the fingertip of the user 13 is positioned to the information processing apparatus 10 via the transmission/reception device 82 as the indication position specification information 94, and then the HMD side processing shifts to step ST178.

In step ST178, the CPU 78A determines whether or not the HMD side processing end condition is satisfied. In step ST178, in a case in which the HMD side processing end condition is not satisfied, a negative determination is made, and the HMD side processing shifts to step ST150 shown in FIG. 28. In step ST178, in a case in which the HMD side processing end condition is satisfied, a positive determination is made, and the HMD side processing ends.

Next, an example of a flow of the image generation processing performed by the CPU 22A of the information processing apparatus 10 will be described with reference to FIG. 30.

In the image generation processing shown in FIG. 30, first, in step ST200, the CPU 22A determines whether or not the provisional indication position inclusion HMD image 88 transmitted by executing the processing of step ST162 of the HMD side processing shown in FIG. 28 is received by the transmission/reception device 24. In step ST200, in a case in which the provisional indication position inclusion HMD image 88 is not received by the transmission/reception device 24, a negative determination is made, and the image generation processing shifts to step ST208. In step ST200, in a case in which the provisional indication position inclusion HMD image 88 is received by the transmission/reception device 24, a positive determination is made, and the image generation processing shifts to step ST202.

In step ST202, the CPU 22A acquires, from the imaging apparatus 30, the captured image showing the subject including the provisional indication position specified from the provisional indication position specification information 88A of the provisional indication position inclusion HMD image 88 received by the transmission/reception device 24 in step ST200, as the different-viewpoint position image 90 showing the state of the inside of the soccer stadium 36 in a case in which the inside of the soccer stadium 36 is observed from the viewpoint position different from the current viewpoint position of the user 13. After the processing of step ST202 is executed, the image generation processing shifts to step ST204.

In step ST204, the CPU 22A acquires the three-dimensional region image 32 from the NVM 22B and generates the indication position candidate inclusion different-viewpoint position image 92 with reference to the acquired three-dimensional region image 32, and the image generation processing shifts to step ST206.

In step ST206, the CPU 22A transmits the indication position candidate inclusion different-viewpoint position image 92 generated in step ST202 to the HMD 68 via the transmission/reception device 24, and then the image generation processing shifts to step ST208.

In step ST208, the CPU 22A determines whether or not the indication position specification information 94 transmitted by executing the processing of step ST176 shown in FIG. 29 is received by the transmission/reception device 24. In step ST208, in a case in which the indication position specification information 94 is not received by the transmission/reception device 24, a negative determination is made, and the image generation processing shifts to step ST216. In step ST208, in a case in which the indication position specification information 94 is received by the transmission/reception device 24, a positive determination is made, and the image generation processing shifts to step ST210.

In step ST210, the CPU 22A extracts the coordinates from the indication position specification information 94 received by the transmission/reception device 24 in step ST208, and then the image generation processing shifts to step ST212.

In step ST212, the CPU 22A generates the virtual viewpoint image 64 by using the viewpoint position determined based on the coordinates extracted from the indication position specification information 94 in step ST210, and then the image generation processing shifts to step ST214.

In step ST214, the CPU 22A transmits the virtual viewpoint image 64 generated in step ST212 to the user device 12 via the transmission/reception device 24, and then the image generation processing shifts to step ST216.

In step ST216, the CPU 22A determines whether or not the image generation processing end condition is satisfied. In a case in which the image generation processing end condition is not satisfied in step ST216, a negative determination is made, and the image generation processing shifts to step ST200. In a case in which the image generation processing end condition is satisfied, a positive determination is made, and the image generation processing ends.

As described above, in the information processing system 66, the CPU 22A acquires the virtual viewpoint image 64 showing the subject present inside the soccer stadium 36 in a case in which the user 13 virtually observes the inside of the soccer stadium 36 from the viewpoint position determined based on the coordinates inside the soccer stadium 36 corresponding to the position that is indicated inside the soccer stadium 36. The virtual viewpoint image 64 acquired by the CPU 22A is displayed on the display 18 of the user device 12. Therefore, with the present configuration, it is possible to cause the user 13 to observe the state inside the soccer stadium 36 from various positions.

In addition, in the information processing system 65, the CPU 22A acquires the virtual viewpoint image 64 showing the subject present inside the soccer stadium 36 in a case in which the inside of the soccer stadium 36 is observed from the position (for example, any of the plurality of indication position candidates) indicated on the line (for example, on the optical axis OA) from the viewpoint (for example, the position of the HMD camera 76 inside the soccer stadium 36) at which the user 13 observes the inside of the soccer stadium 36 toward the gaze point (for example, the provisional indication position) gazed by the user 13, and displays the acquired virtual viewpoint image 64 on the display 18 of the user device 12. Therefore, with the present configuration, it is possible to generate the virtual viewpoint image 64 based on the viewpoint position in which the intention of the user 13 is reflected with higher accuracy than in a case in which there is no room for selecting the indication position corresponding to the viewpoint position used for generating the virtual viewpoint image 64 from among the plurality of candidates.

It should be noted that, in the second embodiment, the indication position candidate inclusion different-viewpoint position image 92 displayed on the display 74 may be the two-dimensional image, but the technology of the present disclosure is not limited to this, and a three-dimensional view image in which the plurality of dot marks 92A or marks (for example, a star mark, a triangle mark, or a square mark) substituting for the plurality of dot marks 92A can be visually recognized via the display 74. The three-dimensional view image may be generated based on, for example, a parallax image obtained by using a plurality of phase difference pixels, or may be generated based on a shake image obtained by applying vibration to the HMD camera 76.

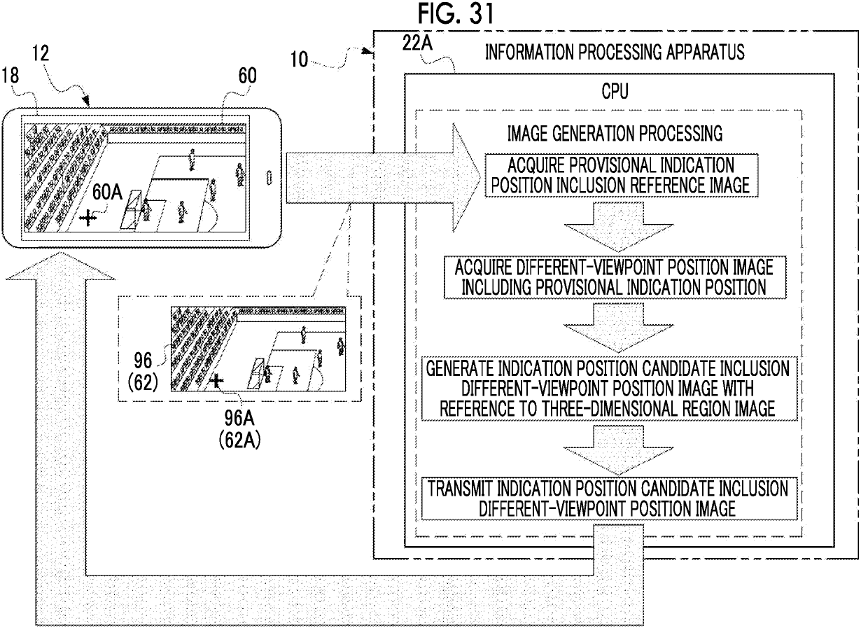

In addition, in the second embodiment, the form example has been described in which, in the image generation processing, the CPU 22A of the information processing apparatus 10 acquires the provisional indication position inclusion HMD image 88 from the HMD 68, but the technology of the present disclosure is not limited to this. For example, as shown in FIG. 31, in the image generation processing, the CPU 22A of the information processing apparatus 10 may acquire a provisional indication position inclusion reference image 96 from the user device 12. The provisional indication position inclusion reference image 96 is an image corresponding to the indication position inclusion reference image 62 described in the first embodiment, and includes provisional indication position specification information 96A. The provisional indication position specification information 96A is information corresponding to the indication position specification information 62A described in the first embodiment. That is, the provisional indication position inclusion reference image 96 is an image obtained by giving the indication position specification information 62A described in the first embodiment to the reference image 60 as the provisional indication position specification information 96A.

In step ST202, the CPU 22A acquires, from the imaging apparatus 30, the captured image showing the subject including the provisional indication position (position corresponding to the indication position described in the first embodiment) specified from the provisional indication position specification information 96A of the provisional indication position inclusion reference image 96, as the different-viewpoint position image 90 showing the state of the inside of the soccer stadium 36 in a case in which the inside of the soccer stadium 36 is observed from the viewpoint position different from the current viewpoint position of the user 13.

The CPU 22A acquires the three-dimensional region image 32 from the NVM 22B, and generates the indication position candidate inclusion different-viewpoint position image 92 with reference to the acquired three-dimensional region image 32. Specifically, first, the CPU 22A specifies the position of the optical axis OA inside the soccer stadium 36 by specifying the feature point that matches between the provisional indication position inclusion reference image 96 and the three-dimensional region image 32. Next, the CPU 22A compares the provisional indication position inclusion reference image 96 with the three-dimensional region image 32, and extracts the coordinates of the provisional indication position inside the soccer stadium 36 from the three-dimensional region image 32 based on a comparison result. Next, the CPU 22A generates the plurality of indication position candidates by the method described in the second embodiment. Then, the CPU 22A gives the information, such as a plurality of indication position candidates, to the different-viewpoint position image 90 to generate the indication position candidate inclusion different-viewpoint position image 92. The CPU 22A transmits the indication position candidate inclusion different-viewpoint position image 92 to the user device 12 via the transmission/reception device 24. In this case, the indication position candidate inclusion different-viewpoint position image 92 is displayed on the display 18 of the user device 12. Then, by selecting any of the dot marks 92A by the user 13 via the touch panel 20, the position intended by the user 13 as the viewpoint position is decided by the CPU 78A, and the indication position specification information 94 is transmitted to the information processing apparatus 10, as in the second embodiment.

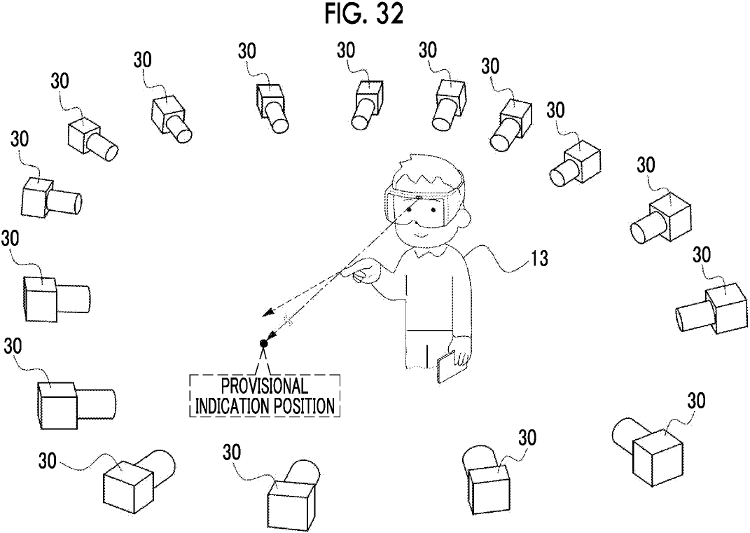

In addition, in the second embodiment, the form example has been described in which the finger of the user 13 is detected based on the HMD image 86 obtained by imaging the finger of the user 13 with the HMD camera 76, but the technology of the present disclosure is not limited to this. For example, as shown in FIG. 32, the finger of the user 13 may be detected from a plurality of captured images captured by the plurality of imaging apparatuses 30 installed inside the soccer stadium 36. Also, the finger of the user 13 may be detected by the CPU 22A, the CPU 78A, or the like based on the HMD image 86 and the plurality of captured images. Also, the method of detecting the finger of the user 13 is not limited to the above, and the finger of the user 13 may be detected by attaching a known device of which a position and a direction can be specified, to the finger of the user 13. In this case, the user 13 points to the viewpoint position by using the finger attached to the device, so that the viewpoint position can be decided as in the embodiment described above. In addition, it is not always necessary to detect the finger of the user 13 to decide the viewpoint position. For example, the viewpoint position may be decided as in the embodiment described above by the user holding the known device of which the position and the direction can be specified and pointing to a specific direction.

In addition, in the second embodiment, the position indicated on the line from the viewpoint at which the soccer stadium 36 is observed toward the gaze point, that is, the position indicated on the optical axis OA is used as the viewpoint position used for generating the virtual viewpoint image 64, but the technology of the present disclosure is not limited to this. For example, a position designated on a line (for example, on the visual line of the user 13) from the viewpoint position 56 (see FIG. 4) toward a point designated inside the image corresponding to the reference image 60 may be used as the viewpoint position used for generating the virtual viewpoint image 64.

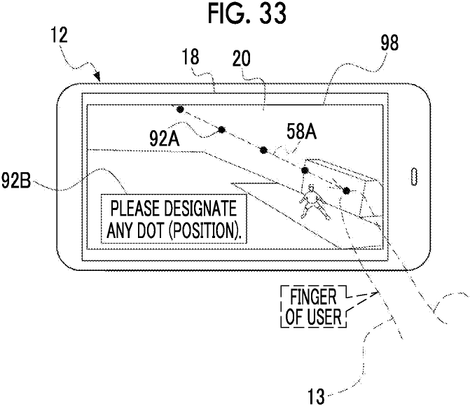

In this case, for example, as shown in FIG. 33, an indication position candidate inclusion different-viewpoint position image 98 need only be displayed on the display 18 of the user device 12. The indication position candidate inclusion different-viewpoint position image 98 is an image corresponding to the indication position candidate inclusion different-viewpoint position image 92, and is different from the indication position candidate inclusion different-viewpoint position image 92 in that the plurality of dot marks 92A are positioned on an image showing a visual line 58A of the user 13 instead of the image showing the optical axis OA. The image showing the visual line 58A does not necessarily have to be displayed, and the image showing the visual line 58A may not be displayed.

The visual line 58A corresponds to the optical axis of the imaging optical system of the imaging apparatus 42 in the example shown in FIG. 4, for example. In this case, by touching the dot mark 92A with the finger of the user 13 via the touch panel 20, a position specified from the coordinates associated with the touched dot mark 92A is used as the viewpoint position used for generating the virtual viewpoint image 64. Therefore, with the present configuration, it is possible to generate the virtual viewpoint image 64 based on the viewpoint position in which the intention of the user 13 is reflected with higher accuracy than in a case in which there is no room for selecting the indication position corresponding to the viewpoint position used for generating the virtual viewpoint image 64 from among the plurality of candidates.

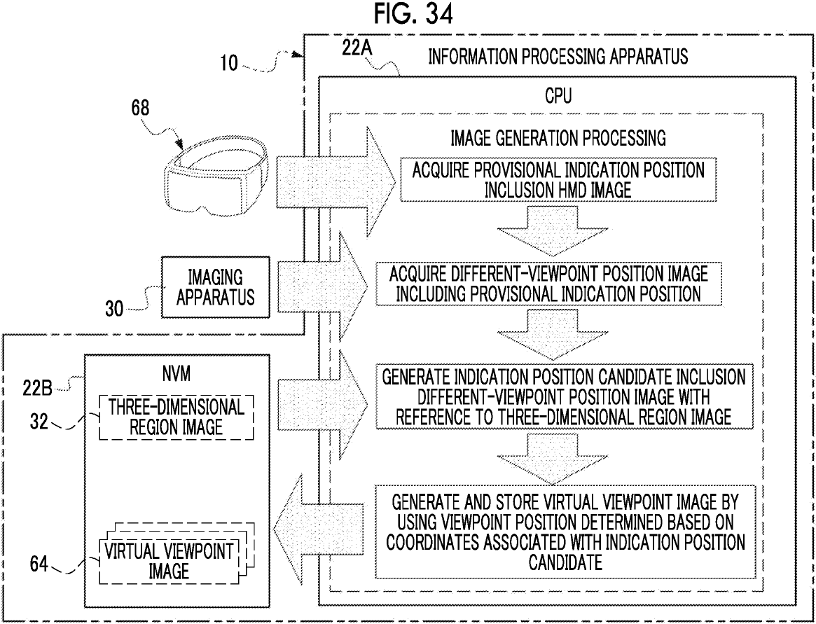

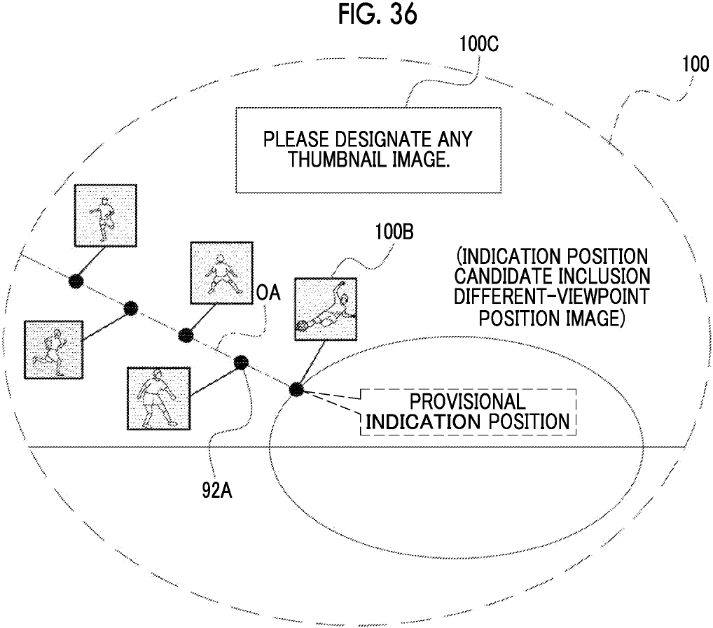

In addition, in the second embodiment, the form example has been described in which the CPU 22A associates the dot mark 92A with the indication position candidate, but the technology of the present disclosure is not limited to this. For example, the CPU 22A may associate the indication position candidate with a thumbnail image 100B (see FIG. 36) obtained by reducing the virtual viewpoint image 64 in a case in which the inside of the soccer stadium 36 is observed. Here, the method of associating the thumbnail image 100B with the indication position candidate and using the thumbnail image 100B will be described with reference to FIGS. 34 to 38.

As shown in FIG. 34 as an example, in the image generation processing of the information processing apparatus 10, the CPU 22A generates an indication position candidate inclusion different-viewpoint position image 100 (see FIG. 36) by the method described in the second embodiment. The CPU 22A generates a plurality of virtual viewpoint images 64 by using each of a plurality of viewpoint positions determined based on each of a plurality of coordinates associated with a plurality of indication position candidates included in the indication position candidate inclusion different-viewpoint position image 100. Then, the CPU 22A stores each of the generated plurality of virtual viewpoint images 64 in the NVM 22B in association with the related indication position candidate.

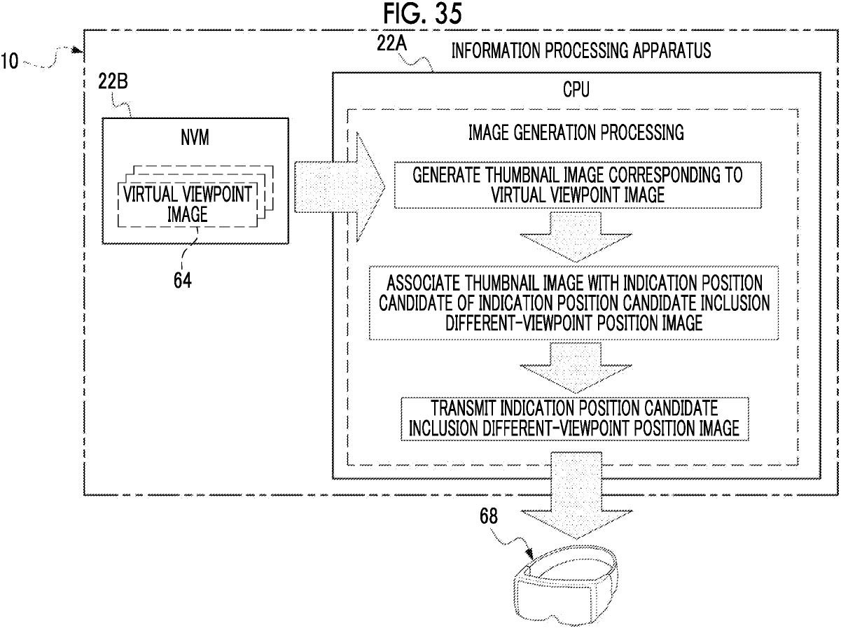

As shown in FIG. 35 as an example, the CPU 22A acquires the plurality of virtual viewpoint images 64 from the NVM 22B and generates a plurality of thumbnail images 100B (see FIG. 36) corresponding to the plurality of virtual viewpoint images 64. The CPU 22A associates the thumbnail image 100B with each of the plurality of indication position candidates included in the indication position candidate inclusion different-viewpoint position image 100. Then, the CPU 22A transmits the indication position candidate inclusion different-viewpoint position image 100 associated with the thumbnail image 100B to the HMD 68 via the transmission/reception device 24 (see FIG. 1). As a result, the indication position candidate inclusion different-viewpoint position image 100 is displayed on the display 74 of the HMD 68.

As shown in FIG. 36 as an example, in the indication position candidate inclusion different-viewpoint position image 100, the plurality of dot marks 92A are disposed at the predetermined interval along the image showing the optical axis OA. The image showing the optical axis OA does not necessarily have to be displayed, and the image showing the optical axis OA may not be displayed.

In addition, in the indication position candidate inclusion different-viewpoint position image 100, the thumbnail image 100B associated with each of the plurality of dot marks 92A is disposed along the image showing the optical axis OA. Further, a message 100C is given to the indication position candidate inclusion different-viewpoint position image 100. The message 100C is a message prompting the user 13 to select the indication position candidate, and in the example shown in FIG. 36, as an example of the message 100C, a message “Please designate any thumbnail image” is shown.

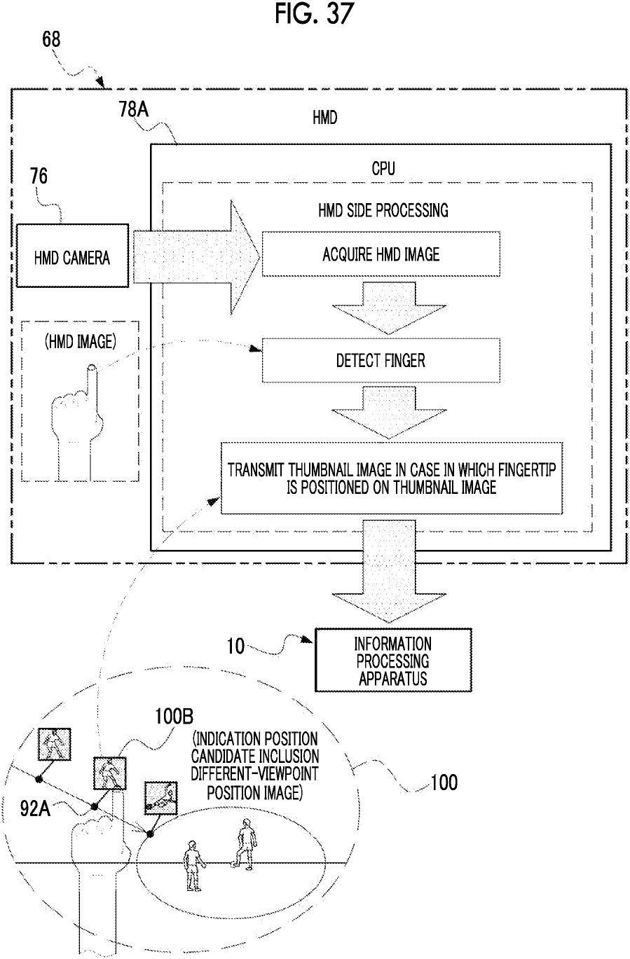

As an example, as shown in FIG. 37, in a case in which the fingertip of the user 13 is positioned any thumbnail image 100B in a state in which the indication position candidate inclusion different-viewpoint position image 100 is displayed on the display 74 of the HMD 68, the CPU 78A transmits the thumbnail image 100B in which the fingertip is positioned to the information processing apparatus 10 via the transmission/reception device 82 (see FIG. 15).

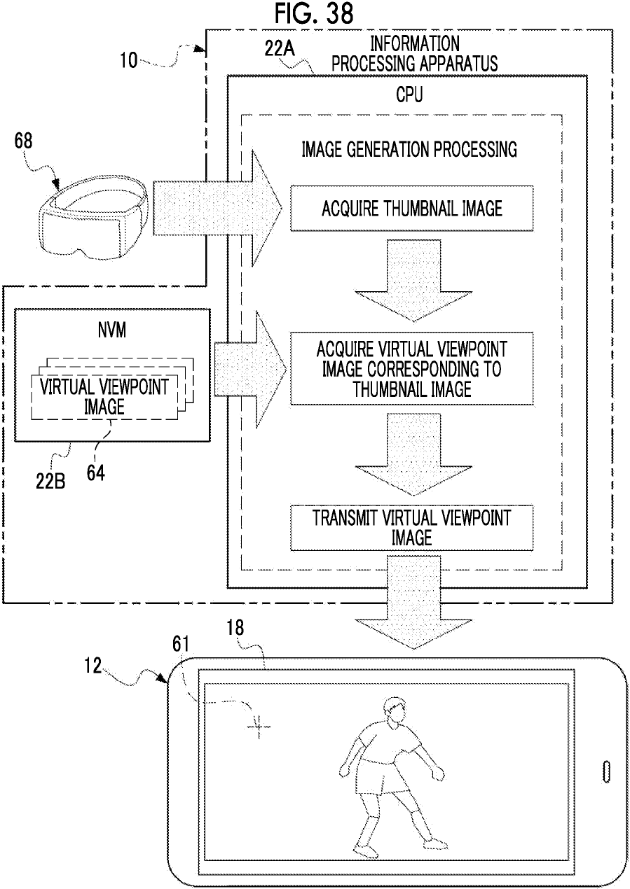

As shown in FIG. 38 as an example, in the image generation processing of the information processing apparatus 10, the CPU 22A acquires the thumbnail image 100B from the HMD 68, and acquires the virtual viewpoint image 64 corresponding to the acquired thumbnail image 100B from the NVM 22B. Then, the CPU 22A transmits the virtual viewpoint image 64 acquired from the NVM 22B to the user device 12 via the transmission/reception device 24 (see FIG. 1). As a result, the virtual viewpoint image 64 is displayed on the display 18 of the user device 12.

As described above, in the examples shown in FIGS. 34 to 38, the thumbnail image 100B is associated with each of the plurality of indication position candidates included in the indication position candidate inclusion different-viewpoint position image 100, the virtual viewpoint image 64 corresponding to the thumbnail image 100B selected by the user 13 is displayed on the display 18 of the user device 12. Therefore, with the present configuration, it is possible to generate the virtual viewpoint image 64 based on the viewpoint position in which the intention of the user 13 is reflected with higher accuracy than in a case in which there is no room for selecting the indication position corresponding to the viewpoint position used for generating the virtual viewpoint image 64 from among the plurality of candidates. Moreover, the user 13 can predict what kind of virtual viewpoint image 64 will be provided from the information processing apparatus 10 through the thumbnail image 100B.

In addition, in the example shown in FIGS. 34 to 38, any one of the thumbnail images 100B is selected by the user 13 in a state in which the indication position candidate inclusion different-viewpoint position image 100 is displayed on the display 74 of the HMD 68, but the technology of the present disclosure is not limited to this. For example, the thumbnail image 100B associated with the indication position candidate on a line (for example, on the image showing the visual line of the user 13) from the viewpoint position 56 (see FIG. 4) toward a point (for example, the provisional indication position) designated inside the image corresponding to the reference image 60 may be selected by the user 13.

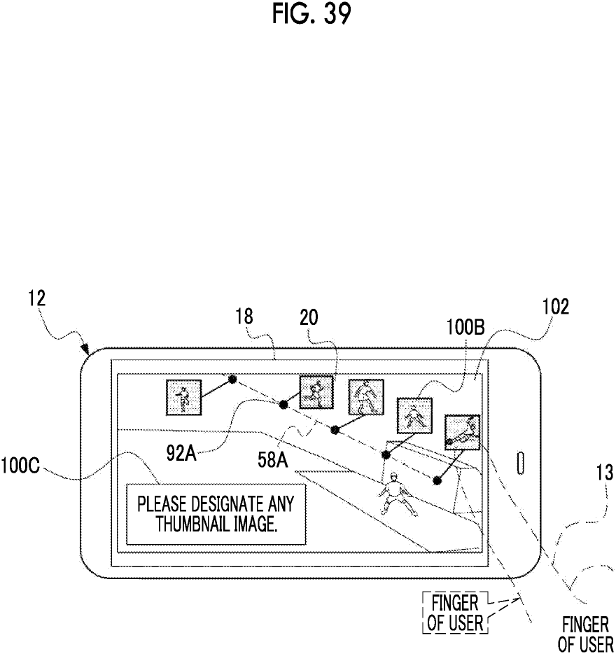

In this case, for example, as shown in FIG. 39, an indication position candidate inclusion different-viewpoint position image 102 need only be displayed on the display 18 of the user device 12. The indication position candidate inclusion different-viewpoint position image 102 is an image corresponding to the indication position candidate inclusion different-viewpoint position image 100, and is different from the indication position candidate inclusion different-viewpoint position image 100 in that the plurality of thumbnail images 100B are positioned on an image showing a visual line 58A of the user 13 instead of the image showing the optical axis OA. The visual line 58A corresponds to the optical axis of the imaging optical system of the imaging apparatus 42 in the example shown in FIG. 4, for example. The thumbnail image 100B displayed on the display 18 of the user device 12 is an example of a “second reduction image” according to the technology of the present disclosure.

In a case in which the plurality of thumbnail images 100B are touched by the finger of the user 13 via the touch panel 20 in a state in which the indication position candidate inclusion different-viewpoint position image 102 is displayed on the display 18 of the user device 12, the virtual viewpoint image 64 corresponding to the touched thumbnail image 100B is transmitted to the user device 12, and is displayed on the display 18 of the user device 12. Therefore, with the present configuration, it is possible to generate the virtual viewpoint image 64 based on the viewpoint position in which the intention of the user 13 is reflected with higher accuracy than in a case in which there is no room for selecting the indication position corresponding to the viewpoint position used for generating the virtual viewpoint image 64 from among the plurality of candidates. Moreover, the user 13 can predict what kind of virtual viewpoint image 64 will be provided from the information processing apparatus 10 through the thumbnail image 100B.

### Third Embodiment

In each of the embodiments described above, the case has been described in which the indication position can be set in an unlimited manner inside the soccer stadium 36. However, in the third embodiment, a case will be described in which a region in which the indication position can be set is limited. In the third embodiment, the same components as the components in each of the embodiments described above will be designated by the same reference numeral, the description thereof will be omitted, and a difference from each of the embodiments described above will be described.

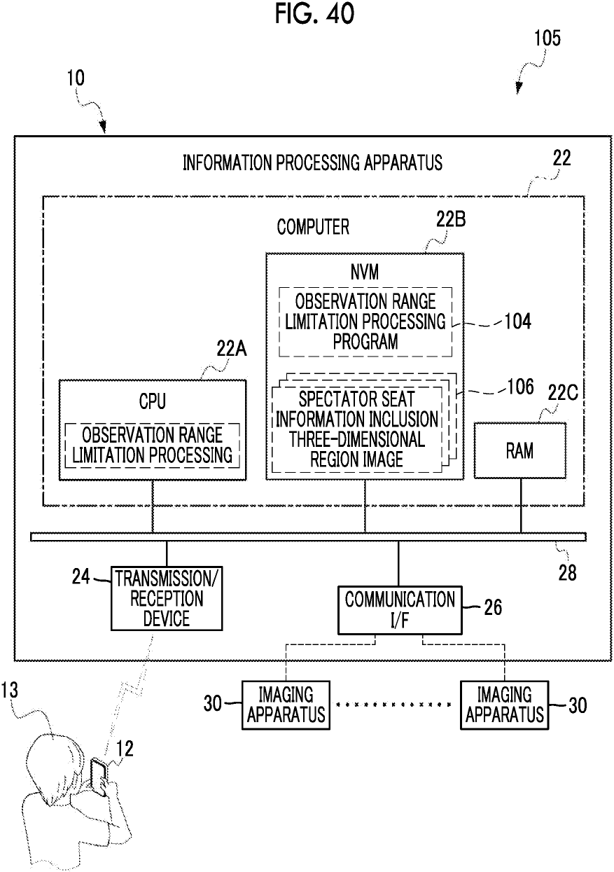

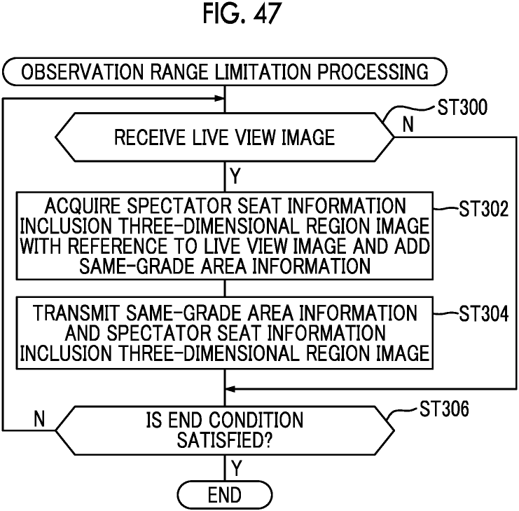

As shown in FIG. 40 as an example, an information processing system 105 according to the third embodiment comprises the information processing apparatus 10 and the user device 12. In the information processing apparatus 10, the NVM 22B stores an observation range limitation processing program 104 and a spectator seat information inclusion three-dimensional region image 106. The CPU 22A performs observation range limitation processing (see FIG. 47) by reading out the observation range limitation processing program 104 from the NVM 22B and executing the observation range limitation processing program 104 on the RAM 22C.

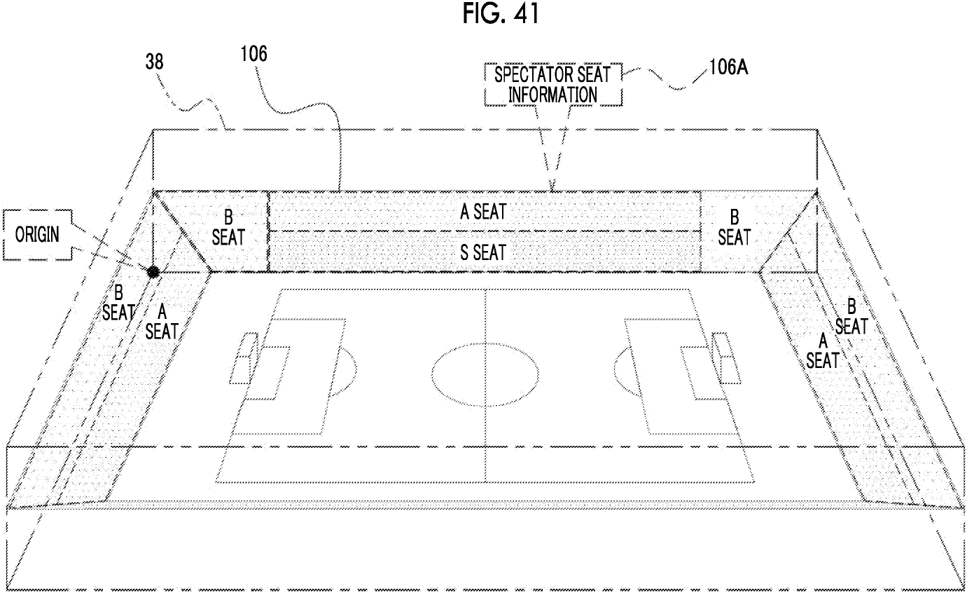

The spectator seat information inclusion three-dimensional region image 106 is an image in which spectator seat information 106A (see FIG. 41) is added to the three-dimensional region image 32 described in the first embodiment. A plurality of spectator seat information inclusion three-dimensional region images 106 are stored in the NVM 22B. The plurality of spectator seat information inclusion three-dimensional region images 106 are images determined for each spectator venue, and are used properly for each spectator venue.

The spectator seats 36B (see FIG. 2) are divided by grade. The grade is determined for each purchase amount of a spectator ticket, and in the example shown in FIG. 41, an area of the spectator seat 36B is differentiated by the grades, such as an S seat, an A seat, and a B seat. As shown in FIG. 41 as an example, the grade of the spectator seat 36B is reflected as the spectator seat information 106A in the spectator seat information inclusion three-dimensional region image 106.

The spectator seat information 106A is information including grade specification information capable of specifying the grade of the spectator seat 36B and coordinates at which each area divided by the grade inside the soccer stadium 36 can be specified. The grade is also given to the position at which the user 13 spectates in the spectator seat 36B, and the user 13 can spectate only in the area of the same grade. That is, in the information processing system 105, the viewpoint position can be set by the user 13 for the area inside the soccer stadium 36 at which the user 13 can spectate, but the user 13 is prohibited from setting the viewpoint position for the other areas.

It should be noted that the user 13 is an example of an “indication source” according to the technology of the present disclosure, and the grade of the spectator seat 36B is an example of an “attribute” according to the technology of the present disclosure.

In the information processing system 105, the grade given to the position at which the user 13 spectates in the spectator seat 36B is specified based on the live view image obtained by the imaging with the user device 12.

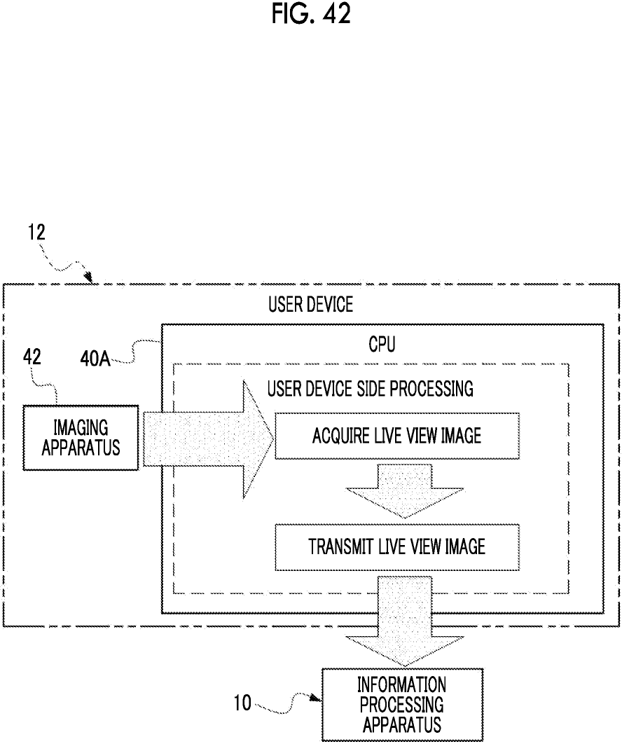

As shown in FIG. 42 as an example, in the user device side processing of the user device 12, the CPU 40A acquires the live view image from the imaging apparatus 42. Then, the CPU 40A transmits the acquired live view image to the information processing apparatus 10 via the transmission/reception device 44 (see FIG. 3).

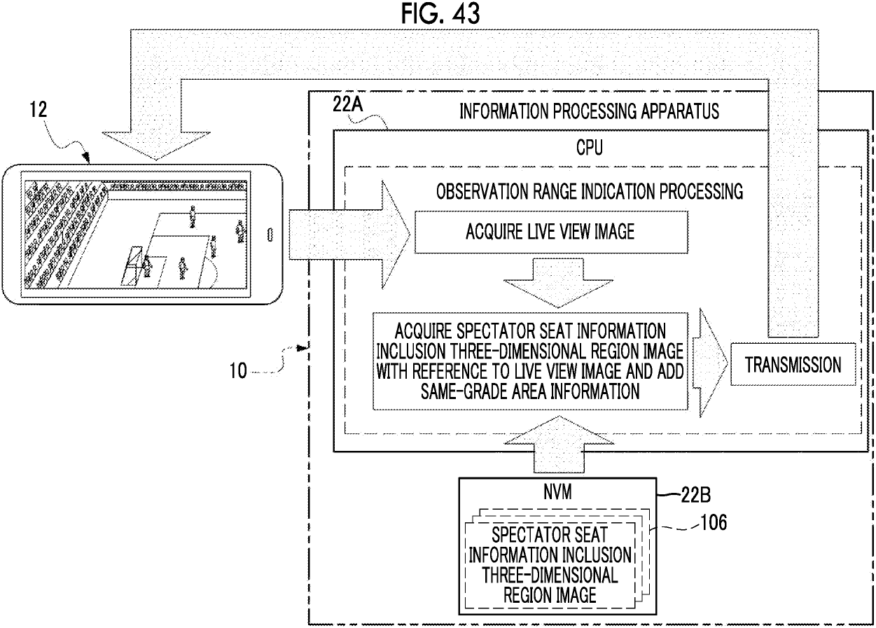

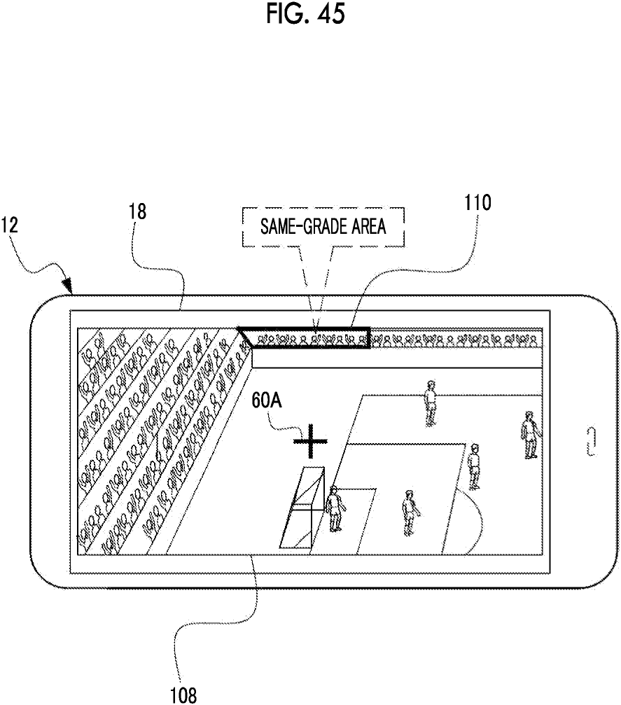

As shown in FIG. 43 as an example, in observation range indication processing of the information processing apparatus 10, the CPU 22A acquires the live view image from the user device 12. The CPU 22A acquires the spectator seat information inclusion three-dimensional region image 106 with reference to the live view image acquired from the user device 12. Specifically, the CPU 22A calculates a rate of match of the feature point between the live view image and the three-dimensional region image 32 included in the spectator seat information inclusion three-dimensional region image 106, and selects and acquires one spectator seat information inclusion three-dimensional region image 106 from among the plurality of spectator seat information inclusion three-dimensional region images 106 based on the calculated rate of match. That is, the CPU 22A acquires the spectator seat information inclusion three-dimensional region image 106 including the three-dimensional region image 32 in which the rate of match of the feature point with the live view image is the maximum. Here, the CPU 22A adds same-grade area information to the spectator seat information inclusion three-dimensional region image 106. The same-grade area information is information (for example, coordinates) capable of specifying a same-grade area 110 (see FIG. 45), which is an area of the same grade as the area in which the user 13 spectates.

The same-grade area information is generated by the CPU 22A based on the live view image and the spectator seat information inclusion three-dimensional region image 106. The CPU 22A specifies the image having the highest rate of match with the live view image among the three-dimensional region images 32 included in the acquired spectator seat information inclusion three-dimensional region image 106, as a user spectating area image showing the area in which the user 13 spectates. The CPU 22A specifies the grade corresponding to the user spectating area image with reference to the spectator seat information inclusion three-dimensional region image 106. The CPU 22A specifies the area of the same grade as the specified grade, that is, the same-grade area 110 with reference to the spectator seat information inclusion three-dimensional region image 106. The CPU 22A adds the same-grade area information, which is information capable of specifying the specified same-grade area 110, to the spectator seat information inclusion three-dimensional region image 106. Then, the CPU 22A transmits the spectator seat information inclusion three-dimensional region image 106 to which the same-grade area information is added, to the user device 12 via the transmission/reception device 24 (see FIG. 40).

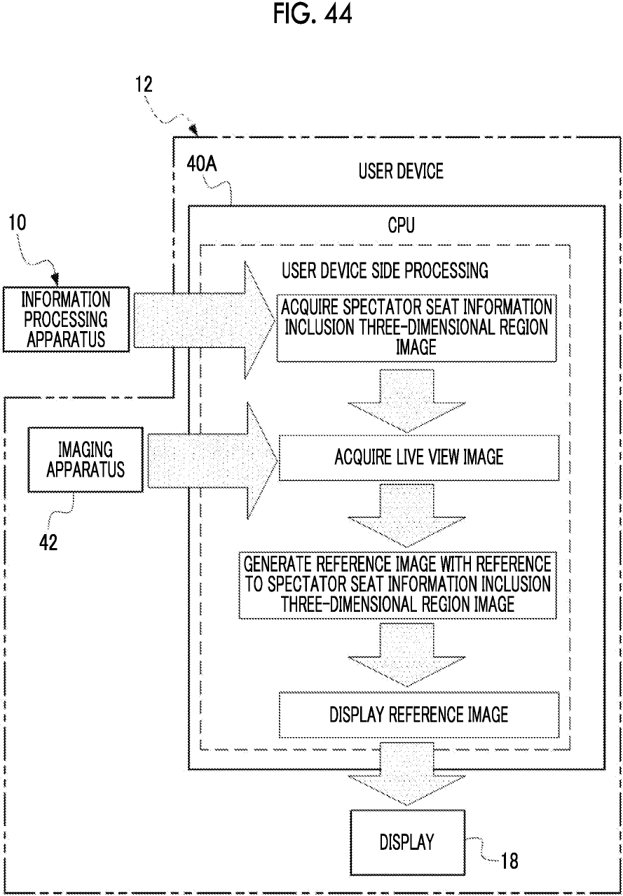

As shown in FIG. 44 as an example, in the user device side processing of the user device 12, the CPU 40A acquires, from the information processing apparatus 10, the spectator seat information inclusion three-dimensional region image 106 to which the same-grade area information is added, and acquires the live view image from the imaging apparatus 42. The CPU 40A generates a reference image 108 (see FIG. 45) which is an image based on the spectator seat information inclusion three-dimensional region image 106 to which the same-grade area information is added. Specifically, the CPU 40A generates the reference image 108 by using the live view image with reference to the same-grade area information and the spectator seat information inclusion three-dimensional region image 106. The CPU 40A displays the reference image 108 on the display 18.

As shown in FIG. 45 as an example, the reference image 108 includes the target mark 60A and the same-grade area 110. The same-grade area 110 is shown in a state of being distinguishable from other areas in the reference image 108. In the example shown in FIG. 45, the same-grade area 110 is bordered by a thick line. In the information processing system 105, the user 13 can set the viewpoint position only for the same-grade area 110. Therefore, even in a case in which the user device 12 requests the information processing apparatus 10 to set the viewpoint position inside an area other than the same-grade area 110 by the same method as in the first embodiment, the information processing apparatus 10 does not respond to the request from the user device 12 for setting the viewpoint position.

It should be noted that the spectator seat information inclusion three-dimensional region image 106 to which the same-grade area information is added is an example of a “three-dimensional region inside-state image” according to the technology of the present disclosure. Also, the same-grade area 110 is an example of an “observation position indication range” according to the technology of the present disclosure.

Subsequently, an action of the information processing system 105 will be described.

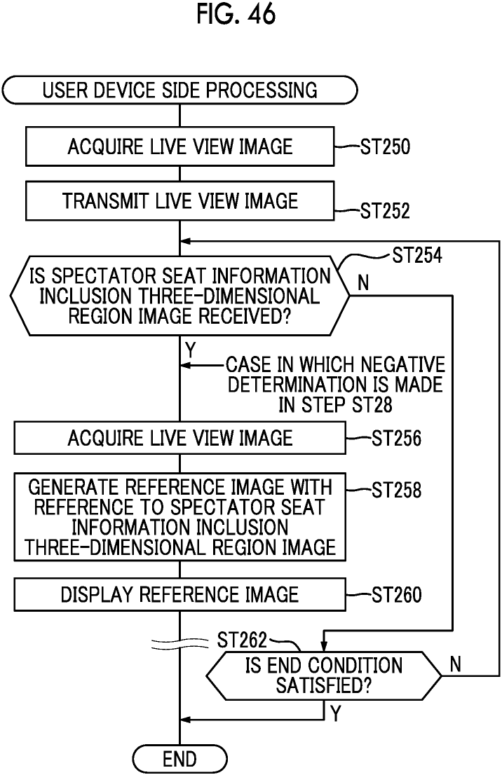

First, an example of a flow of the user device side processing performed by the CPU 40A of the user device 12 will be described with reference to FIG. 46. It should be noted that the flowchart shown in FIG. 46 is different from the flowchart shown in FIG. 11 in that step ST250 to step ST262 are provided before step ST10 of the flowchart shown in FIG. 11. Hereinafter, only steps different from the flowchart shown in FIG. 11 will be described.

In the user device side processing shown in FIG. 46, first, in step ST250, the CPU 40A acquires the live view image from the imaging apparatus 42, and then the user device side processing shifts to step ST252.

In step ST252, the CPU 40A transmits the live view image acquired in step ST250 to the information processing apparatus 10 via the transmission/reception device 44 (see FIG. 3), and then the user device side processing shifts to step ST254.

In step ST254, the CPU 40A determines whether or not the same-grade area information and the spectator seat information inclusion three-dimensional region image 106 transmitted by executing the processing of step ST304 shown in FIG. 47 is received by the transmission/reception device 44 (see FIG. 3). In step ST254, in a case in which the spectator seat information inclusion three-dimensional region image 106 is not received by the transmission/reception device 44, a negative determination is made, and the user device side processing shifts to step ST262. In step ST254, in a case in which the spectator seat information inclusion three-dimensional region image 106 is received by the transmission/reception device 44, a positive determination is made, and the user device side processing shifts to step ST256.

In step ST262, the CPU 40A determines whether or not the user device side processing end condition is satisfied. In step ST262, in a case in which the user device side processing end condition is not satisfied, a negative determination is made, and the user device side processing shifts to step ST254. In step ST262, in a case in which the user device side processing end condition is satisfied, a positive determination is made, and the user device side processing shifts to step ST256.

In step ST256, the CPU 40A generates the reference image 108 by using the live view image acquired in step ST256 with reference to the same-grade area information and the spectator seat information inclusion three-dimensional region image 106 received by the transmission/reception device 44 in step ST254, and the user device side processing shifts to step ST260.

In step ST260, the CPU 40A displays the reference image 108 generated in step ST258 on the display 18, and then the user device side processing shifts to step ST10 (see FIG. 11).

Subsequently, an example of the flow of the observation range limitation processing performed by the CPU 22A of the information processing apparatus 10 will be described with reference to FIG. 47.

In the observation range limitation processing shown in FIG. 47, first, in step ST300, the CPU 22A determines whether or not the live view image transmitted by executing the processing of step ST252 shown in FIG. 46 is received by the transmission/reception device 24 (see FIG. 40). In step ST300, in a case in which the live view image is not received by the transmission/reception device 24, a negative determination is made, and the observation range limitation processing shifts to step ST306. In step ST300, in a case in which the live view image is received by the transmission/reception device 24, a positive determination is made, and the observation range limitation processing shifts to step ST302.

In step ST302, the CPU 22A acquires the spectator seat information inclusion three-dimensional region image 106 from the NVM 22B with reference to the live view image received by the transmission/reception device 24 in step ST300. Moreover, the CPU 22A generates the same-grade area information based on the live view image received by the transmission/reception device 24 in step ST300 and the spectator seat information inclusion three-dimensional region image 106 acquired from the NVM 22B. Then, the CPU 22A adds the same-grade area information to the generated spectator seat information inclusion three-dimensional region image 106. After the processing of step ST302 is executed, the observation range limitation processing shifts to step ST304.

In step ST304, the CPU 22A transmits the same-grade area information and the spectator seat information inclusion three-dimensional region image 106 obtained in step ST304, that is, the spectator seat information inclusion three-dimensional region image 106 to which the same-grade area information is added, to the user device 12, and then the observation range limitation processing shifts to step ST306.

In step ST306, the CPU 22A determines whether or not a condition for ending the observation range limitation processing (hereinafter, referred to as an “observation range limitation processing end condition”) is satisfied. A first example of the observation range limitation processing end condition is a condition in which an instruction to end the observation range limitation processing is given to the information processing apparatus 10 by a manager or the like of the information processing apparatus 10. A second example of the observation range limitation processing end condition is a condition in which a fourth predetermined time (for example, 10 hours) has elapsed from the start of the execution of the observation range limitation processing. A third example of the observation range limitation processing end condition is a condition in which the processing capacity of the CPU 22A is reduced to less than a reference level.

In step ST306, in a case in which the observation range limitation processing end condition is not satisfied, a negative determination is made, and the observation range limitation processing shifts to step ST300. In a case in which the observation range limitation processing end condition is satisfied, a positive determination is made, and the observation range limitation processing ends.

As described above, in the information processing system 105, the same-grade area 110 is decided in which the viewpoint position can be set according to the grade of the spectator seat 36B by adding the same-grade area information to the spectator seat information inclusion three-dimensional region image 106. The same-grade area 110 is reflected in the reference image 108 (see FIG. 45). The reference image 108 in which the same-grade area 110 is reflected is displayed on the display 18 of the user device 12. Therefore, with the present configuration, the user 13 can visually recognize the area in which the viewpoint position can be set.

In addition, in the information processing system 105, the CPU 22A generates the spectator seat information inclusion three-dimensional region image 106 to which the same-grade area information is added. The same-grade area information is the information capable of specifying the same-grade area 110 which is the area of the same grade as the area in which the user 13 spectates. That is, the spectator seat information inclusion three-dimensional region image 106 to which the same-grade area information is added is an image in which the same-grade area 110 can be distinguished from the other areas. Therefore, with the present configuration, it is possible for the user 13 to more easily grasp an area in which the viewpoint position can be set and an area in which the viewpoint position cannot be set than in a case in which an image in which the same-grade area 110 and other areas cannot be distinguished is used.

In addition, in the information processing system 105, the reference image 108 (see FIG. 45) is an image based on the same-grade area information and the spectator seat information inclusion three-dimensional region image 106. That is, the reference image 108 is an image in which the same-grade area 110 can be specified, and is displayed on the display 18 of the user device 12. Therefore, with the present configuration, the user 13 can visually recognize the area in which the viewpoint position can be set.

It should be noted that, in the third embodiment, the form example has been described in which the range (in the example shown in FIG. 45, the same-grade area 110) in which the observation position can be indicated according to the grade of the spectator seat 36B is decided by the CPU 22A, but the technology of the present disclosure is not limited to this. For example, the range in which the observation position can be indicated according to the attribute of the user 13, such as a team color supported by the user 13, a favorite color of the user 13, a gender of the user 13, an age group of the user 13, and clothes of the user 13, together with the grade of the spectator seat 36B or instead of the grade of the spectator seat 36B may be decided by the CPU 22A. In this case, for example, the NVM 22B need only store in advance an attribute information inclusion three-dimensional region image to which information capable of specifying the attribute of the user 13 is given to the three-dimensional region image 32. In addition, the range in which the observation position can be indicated according to the grade of the spectator seat 36B is not limited to the same-grade area, and may be any range. In addition, the range in which the observation position can be indicated according to the grade of the spectator seat 36B does not have to be divided by the range of the spectator seat, and may be divided, for example, inside the soccer field 36A. More specifically, for example, the observation position closer to the goal may be able to be indicated as the grade of the spectator seat 36B is increased.

In addition, in the third embodiment, the form example has been described in which the reference image 108 is displayed on the display 18 of the user device 12, but the technology of the present disclosure is not limited to this, and the reference image 108 may be displayed on the display 74 of the HMD 68.

In addition, in each of the embodiments described above, the soccer stadium 36 has been described as an example, but the technology of the present disclosure is not limited to this. Any place may be used as long as the place is a place in which the plurality of imaging apparatuses 30 can be installed, such as a baseball field, a rugby field, a curling field, an athletic field, a swimming pool, a concert hall, an outdoor music field, and a theater.

In addition, in each of the embodiments described above, the computer 22 is described as an example, but the technology of the present disclosure is not limited to this. For example, instead of the computer 22, a device including an ASIC, an FPGA, and/or a PLD may be applied. Moreover, instead of the computer 22, a hardware configuration and a software configuration may be used in combination. The same applies to the computers 40 and 78.

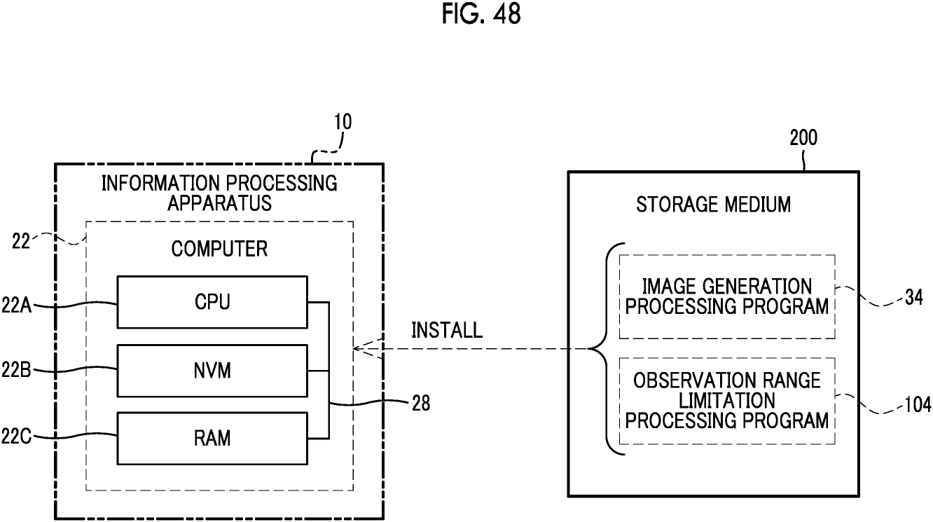

In addition, in the above-described embodiment, the image generation processing program 34 and the observation range limitation processing program 104 (hereinafter, referred to as “programs” in a case in which the distinguishing therebetween is not necessary) are stored in the NVM 22B, but the technology of the present disclosure is not limited to this. As shown in FIG. 48 as an example, the programs may be stored in any portable storage medium 200, such as an SSD or a USB memory which is a non-transitory storage medium. In this case, the programs stored in the storage medium 200 are installed in the computer 22, and the CPU 22A executes the image generation processing and the observation range limitation processing (hereinafter, referred to as “specific processing” in a case in which the distinguishing therebetween is not necessary) according to the programs.

In addition, the programs may be stored in a storage unit of another computer or server device connected to the computer 22 via a communication network (not shown), and the programs may be downloaded to the information processing apparatus 10 in response to a request of the information processing apparatus 10. In this case, the CPU 22A of the computer 22 executes the specific processing based on the downloaded program.

In addition, in each of the embodiments described above, the CPU 22A has been described as an example, but the technology of the present disclosure is not limited to this, and a GPU may be adopted. Moreover, a plurality of CPUs may be adopted instead of the CPU 22A. That is, the specific processing may be executed by one processor or a plurality of processors which are physically separated.

The following various processors can be used as a hardware resource for executing the specific processing. As described above, examples of the processor include the CPU, which is a general-purpose processor that functions as the hardware resource for executing the specific processing according to software, that is, the program. In addition, another example of the processor includes a dedicated electric circuit which is a processor having a circuit configuration specially designed for executing the dedicated processing, such as the FPGA, the PLD, or the ASIC. The memory is built in or connected to any processor, and any processor executes the specific processing by using the memory.

The hardware resource for executing the specific processing may be configured by one of these various processors, or may be configured by a combination (for example, a combination of a plurality of FPGAs or a combination of the CPU and the FPGA) of two or more processors of the same type or different types. In addition, the hardware resource for executing the specific processing may be one processor.

A first example in which the hardware resource is configured by one processor is a form in which one processor is configured by a combination of one or more CPUs and software, and the processor functions as the hardware resource for executing the specific processing, as represented by a computer, such as a client and a server. A second example thereof is a form in which a processor that realizes the functions of the entire system including a plurality of hardware resources for executing the specific processing with one IC chip is used, as represented by SoC. As described above, the specific processing is realized by using one or more of the various processors as the hardware resources.

Further, as the hardware structures of these various processors, more specifically, an electric circuit in which circuit elements, such as semiconductor elements, are combined can be used.

In addition, the specific processing described above is merely an example. Therefore, it is needless to say that unnecessary steps may be deleted, new steps may be added, or the processing order may be changed within a range that does not deviate from the gist.

The described contents and the shown contents are the detailed description of the parts according to the technology of the present disclosure, and are merely examples of the technology of the present disclosure. For example, the description of the configuration, the function, the action, and the effect are the description of examples of the configuration, the function, the action, and the effect of the parts according to the technology of the present disclosure. Accordingly, it is needless to say that unnecessary parts may be deleted, new elements may be added, or replacements may be made with respect to the described contents and the shown contents within a range that does not deviate from the gist of the technology of the present disclosure. In addition, in order to avoid complications and facilitate understanding of the parts according to the technology of the present disclosure, the description of common technical knowledge or the like, which does not particularly require the description for enabling the implementation of the technology of the present disclosure, is omitted in the described contents and the shown contents.

In the present specification, “A and/or B” is synonymous with “at least one of A or B”. That is, “A and/or B” means that it may be only A, only B, or a combination of A and B. In addition, in the present specification, in a case in which three or more matters are associated and expressed by “and/or”, the same concept as “A and/or B” is applied.

All documents, patent applications, and technical standards described in the present specification are incorporated into the present specification by reference to the same extent as in a case in which the individual documents, patent applications, and technical standards are specifically and individually stated to be described by reference.

What is claimed is:

1. An information processing apparatus comprising:
a processor; and
a memory built in or connected to the processor,
wherein the processor acquires a subject image showing a subject present inside a three-dimensional region, which is an observation target, in a case in which an inside of the three-dimensional region is observed from a viewpoint position determined based on coordinates inside the three-dimensional region corresponding to an indication position that is indicated inside the three-dimensional region or that is indicated inside a reference image showing a state of the inside of the three-dimensional region in a case in which the inside of the three-dimensional region is observed from a reference position.

2. The information processing apparatus according to claim 1,
wherein the processor derives the coordinates based on an observation state in which the inside of the three-dimensional region is observed, and the indication position.

3. The information processing apparatus according to claim 2,
wherein the observation state is determined according to an observation position at which the inside of the three-dimensional region is observed.

4. The information processing apparatus according to claim 3,
wherein the processor decides an observation position indication range in which the observation position is able to be indicated, according to an attribute of an indication source.

5. The information processing apparatus according to claim 4,
wherein the processor acquires a three-dimensional region inside-state image showing a state of the inside of the three-dimensional region in a case in which the three-dimensional region is observed in the observation state, and
the three-dimensional region inside-state image is an image in which the observation position indication range inside the three-dimensional region and a range other than the observation position indication range are shown in a state of being distinguishable from each other.

6. The information processing apparatus according to claim 5,
wherein the reference image is an image based on the three-dimensional region inside-state image.

7. The information processing apparatus according to claim 2,
wherein the processor derives the coordinates based on a correspondence relationship between an image showing a state of the inside of the three-dimensional region in a case in which the inside of the three-dimensional region is observed in the observation state and a three-dimensional region image in which the three-dimensional region is shown and a position is able to be specified by the coordinates.

8. The information processing apparatus according to claim 1,
wherein the reference image is a virtual viewpoint image generated based on a plurality of images obtained by imaging the inside of the three-dimensional region with a plurality of imaging apparatuses or an image based on a captured image obtained by imaging the inside of the three-dimensional region.

9. The information processing apparatus according to claim 8,
wherein the indication position indicated inside the reference image is a specific position inside the virtual viewpoint image or inside the captured image.

10. The information processing apparatus according to claim 1,
wherein the reference image is an image including a first mark at which the indication position inside the reference image is able to be specified.

11. The information processing apparatus according to claim 1,
wherein the subject image includes a second mark at which the indication position indicated inside the reference image is able to be specified.

12. The information processing apparatus according to claim 1,
wherein, in a case in which an object image showing an object present inside the three-dimensional region in a case in which the inside of the three-dimensional region is observed from a position within a range in which a distance from the indication position is equal to or less than a threshold value is stored in a storage region, the processor acquires the object image instead of the subject image.

13. The information processing apparatus according to claim 1,
wherein the coordinates related to a specific region inside the three-dimensional region are coordinates indicating a position higher than an actual position of the specific region inside the three-dimensional region.

14. The information processing apparatus according to claim 1,
wherein the indication position indicated inside the three-dimensional region is a position indicated on a first line from a viewpoint at which the inside of the three-dimensional region is observed toward a gaze point, and
the indication position indicated inside the reference image is a position indicated on a second line from the reference position toward a point designated inside the reference image.

15. The information processing apparatus according to claim 1,
wherein the indication position indicated inside the three-dimensional region is a position selected from at least one first candidate position,
the indication position indicated inside the reference image is a position selected from at least one second candidate position, and
the processor
associates a first reduction image obtained by reducing the subject image in a case in which the inside of the three-dimensional region is observed from the first candidate position, with the at least one first candidate position, and
associates a second reduction image obtained by reducing the subject image in a case in which the inside of the three-dimensional region is observed from the second candidate position, with the at least one second candidate position.

16. The information processing apparatus according to claim 1,
wherein the processor detects the indication position based on a designated region image showing a region designated inside the three-dimensional region.

17. The information processing apparatus according to claim 1,
wherein the subject image is a virtual viewpoint image generated based on a plurality of images obtained by imaging the inside of the three-dimensional region with a plurality of imaging apparatuses.

18. An information processing method comprising:
acquiring a subject image showing a subject present inside a three-dimensional region, which is an observation target, in a case in which an inside of the three-dimensional region is observed from a viewpoint position determined based on coordinates inside the three-dimensional region corresponding to an indication position that is indicated inside the three-dimensional region or that is indicated inside a reference image showing a state of the inside of the three-dimensional region in a case in which the inside of the three-dimensional region is observed from a reference position.

19. A non-transitory computer-readable storage medium storing a program executable by a computer to perform a process comprising:
acquiring a subject image showing a subject present inside a three-dimensional region, which is an observation target, in a case in which an inside of the three-dimensional region is observed from a viewpoint position determined based on coordinates inside the three-dimensional region corresponding to an indication position that is indicated inside the three-dimensional region or that is indicated inside a reference image showing a state of the inside of the three-dimensional region in a case in which the inside of the three-dimensional region is observed from a reference position.
